(19) United States
(12) Patent Application Publication
(10) Pub. No.: US 2026/0247075 A1
(43) Pub. Date: Aug. 20, 2026

(54) SLEEP MODES FOR PLUGGED-IN PLAYERS

(71) Applicant: Sonos, Inc., Goleta, CA (US)

(72) Inventors: Won So, Boston, MA (US); Anaïs Choi Sarrazin, San Francisco, CA (US); Jason Morris Yore, Santa Barbara, CA (US)

(21) Appl. No.: 19/162,634

(22) PCT Filed: Mar. 4, 2024
(86) PCT No.: PCT/US2024/018352

§ 371 Date: Sep. 5, 2025

Related U.S. Application Data
(60) Provisional application No. 63/488,605, filed on Mar. 6, 2023.
(60) Provisional application No. 63/488,606, filed on Mar. 6, 2023.

(51) Int. Cl. H04R 3/12; H04R 27/00

(52) U.S. Cl. CPC H04R 3/12; H04R 27/00; H04R 2227/005; H04R 2420/01; H04R 2420/03; H04R 2420/05; H04R 2420/07

(57) ABSTRACT

An example playback device includes a non-transitory computer-readable medium storing instructions executable by a processor to control the playback device to play audio content synchronously with another playback device in a bonded group, determine, while the playback device is in the bonded group, that control information instructing the playback device to play the audio content has not been received for a predetermined time interval, based on the determination, cause the other playback device to enter a suspended state in which an operating system and one or more programs, including a control program configured to instruct the other playback device to play the audio content, are suspended, monitor for a wake-up indicator while the other playback device is in the suspended state, and based on detecting the wake-up indicator, cause the other playback device to resume execution of the operating system and the one or more programs.

### CROSS-REFERENCE TO RELATED APPLICATIONS

This application claims priority to co-pending U.S. Provisional Application No. 63/488,605 filed on Mar. 6, 2023 and to co-pending U.S. Provisional Application No. 63/488,606 filed on Mar. 6, 2023, each of which is hereby incorporated herein by reference in its entirety for all purposes.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when Sonos, Inc. began development of a new type of playback system. Sonos then filed one of its first patent applications in 2003, entitled “Method for Synchronizing Audio Playback between Multiple Networked Devices,” and began offering its first media playback systems for sale in 2005. The SONOS Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 1C is a block diagram of a playback device.

FIG. 1D is a block diagram of a playback device.

FIG. 1E is a block diagram of a bonded playback device.

FIG. 1F is a block diagram of a network microphone device.

FIG. 1G is a block diagram of a playback device.

FIG. 1H is a partial schematic diagram of a control device.

FIGS. 1I through 1L are schematic diagrams of corresponding media playback system zones.

FIG. 1M is a schematic diagram of media playback system areas.

FIG. 2A is a front isometric view of a playback device configured in accordance with aspects of the disclosed technology.

FIG. 2B is a front isometric view of the playback device of FIG. 2A without a grille.

FIG. 2C is an exploded view of the playback device of FIG. 2A.

FIG. 3A is a front view of a network microphone device configured in accordance with aspects of the disclosed technology.

FIG. 3B is a side isometric view of the network microphone device of FIG. 3A.

FIG. 3C is an exploded view of the network microphone device of FIGS. 3A and 3B.

FIG. 3D is an enlarged view of a portion of FIG. 3B.

FIG. 3E is a block diagram of the network microphone device of FIGS. 3A-3D.

FIG. 3F is a schematic diagram of an example voice input.

FIG. 4 is a diagram illustrating software components of an example playback device in accordance with aspects of the disclosed technology.

FIG. 5 is a block diagram of circuitry that may be included in a sleep-capable playback device in accordance with aspects of the disclosed technology.

FIG. 6 is a diagram of an example media playback system in accordance with aspects of the disclosed technology.

FIG. 7 is a sequence diagram illustrating an example of a method in accordance with aspects of the disclosed technology.

FIG. 8 is a flow diagram of an example of a method in accordance with aspects of the disclosed technology.

FIG. 9A is a block diagram of one example of a bonded group in accordance with aspects of the disclosed technology.

FIG. 9B is a block diagram of another example of a bonded group in accordance with aspects of the disclosed technology.

FIG. 10 is a sequence diagram illustrating another example of a method in accordance with aspects of the disclosed technology.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Embodiments described herein relate to power-saving mechanisms and methodologies that can be applied to and implemented by one or more playback devices in a media playback system. Environmental concerns, as well as many new and evolving regulations, can drive a need for various electronic devices, including playback devices, to consume less energy. Although power-saving features may often be implemented in battery-operated devices, “always-powered” (e.g., “plugged in”) devices have generally lacked such features. However, growing awareness of the need to reduce energy consumption may make desirable the ability to implement power-saving features even in always-powered devices and/or battery-powered devices that are “docked” or otherwise attached to an external power source (e.g., plugged in). Furthermore, in implementing power-saving features, it is desirable to avoid loss of ability to respond to user input and commands (e.g., to begin playback of music or other audio content) and to minimize requirements for users to manually “turn off” power-saving features or otherwise reactivate playback devices that may be in a power-saving mode. Accordingly, aspects and embodiments disclosed herein provide techniques by which power consumption of playback devices can be reduced with minimal disruption to users' listening experiences. In addition, examples provide users options for whether or not to engage power saving features, and when to do so, thus providing a flexible and customizable approach to power-saving that can be controlled by the users.

In many media playback systems, one or more playback devices may typically spend considerable time in an inactive or idle state, in which the playback device is not actively playing music or other audio content. Such circumstances provide an ideal opportunity for power savings that do not impact the user's listening experience. According to certain aspects, one or more idle playback devices in a media playback system can be configured to enter a suspended (also referred to as a “sleep”) state, in which certain electronic components are powered down to reduce energy consumption. One or more other playback devices in the media playback system, whether idle or not, can remain active, or retain sufficient operating functionality (even while some components may be powered down), to monitor for a condition that indicates a need for one or more of the playback device(s) in the suspended state to become active, and to direct or cause those playback devices to exit the suspended state (e.g., to “wake”) and resume normal operations. In this manner, the system overall can implement significant power savings, while preserving the ability to respond to user commands or needs with minimal or no disruption to the user's experience with their media playback system.

In some embodiments, for example, a playback device comprises a communications interface including a wireless radio, one or more speakers, one or more amplifiers configured to drive the one or more speakers, at least one processor, and at least one non-transitory computer-readable medium coupled to the at least one processor. The at least one non-transitory computer-readable medium comprises program instructions that are executable by the at least one processor to control the playback device to play back audio content, via the one or more speakers and the one or more amplifiers, synchronously with at least one other playback device; based on a sleep indication, direct, via communication of at least one message to the at least one other playback device using the wireless radio, the at least one other playback device to enter a suspended state in which the at least one other playback device suspends an operating system and one or more programs, the one or more programs including a control program configured to instruct the at least one other playback device to play back the audio content; while the at least one other playback device is in the suspended state, monitor for a wake-up indication; and based on detection of the wake-up indication, direct, via communication of at least one message to the at least one other playback device using the wireless radio, the at least one other playback device to resume execution of the operating system and the one or more programs.

In some embodiments, for example, a method of operating a plurality of playback devices configured as a bonded group comprises determining that, for a predetermined time period, the bonded group of playback devices has not received control information directing the bonded group of playback devices to play back audio content, based on this determination, selecting one or more playback devices in the bonded group to identify a subset of playback devices to enter a suspended state, and sending sleep instructions to the subset of playback devices to cause each playback device in the subset of playback devices to suspend an operating system and one or more programs, the one or more programs including a control program configured to instruct a respective playback device to play back the audio content in synchrony with other playback devices in the bonded group. Various embodiments include playback devices that are configured to execute examples of the methods disclosed herein.

While some examples described herein may refer to functions performed by given actors such as “users,” “listeners,” and/or other entities, it should be understood that such references are for purposes of explanation only. The claims should not be interpreted to require action by any such example actor unless explicitly required by the language of the claims themselves.

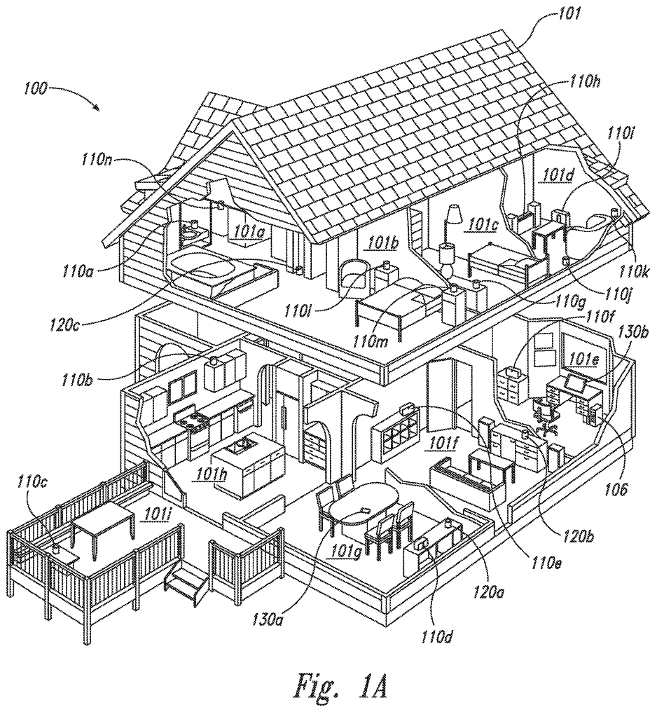

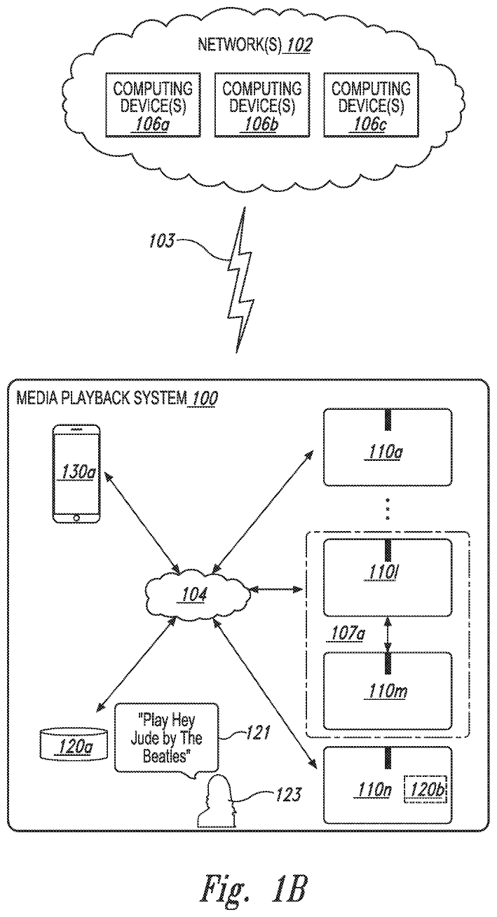

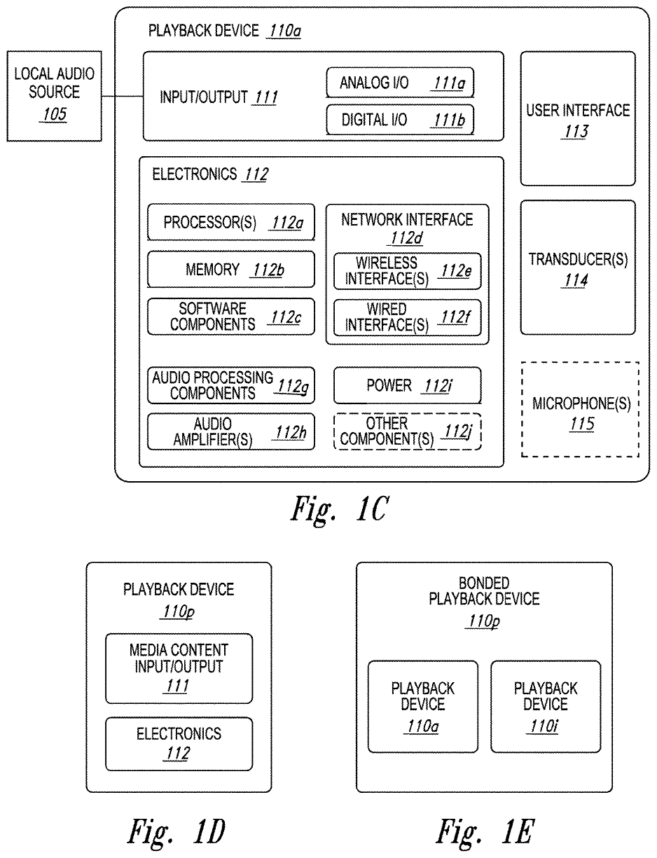

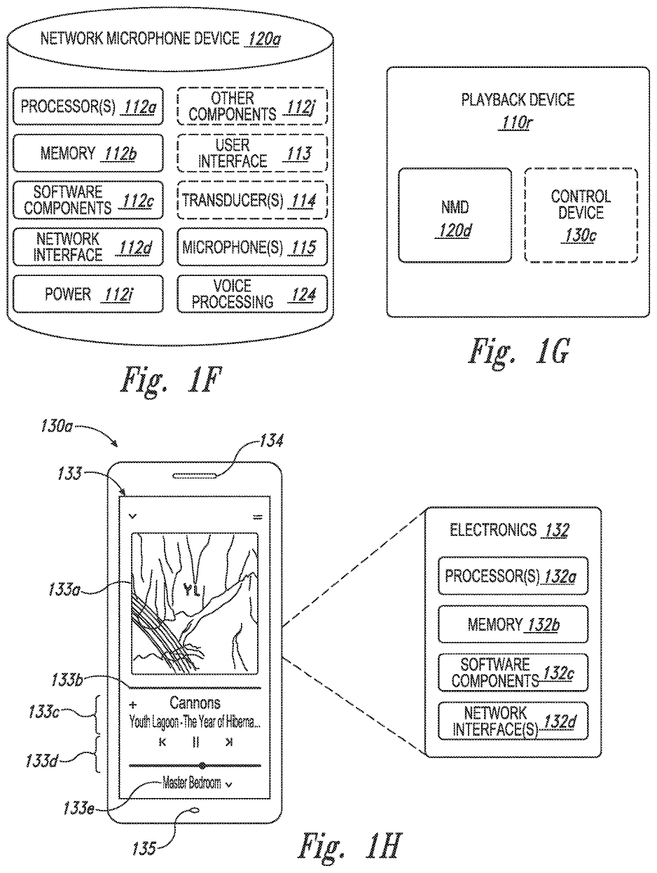

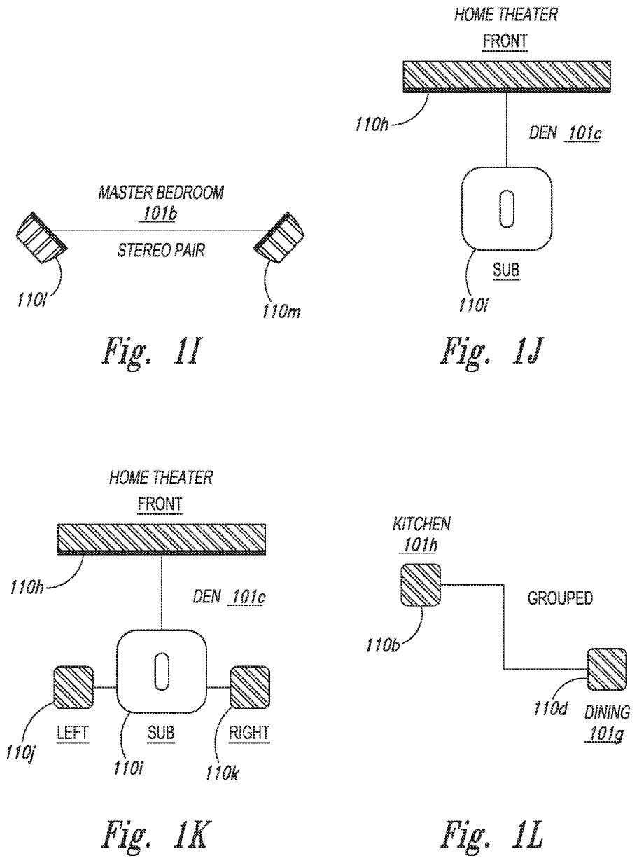

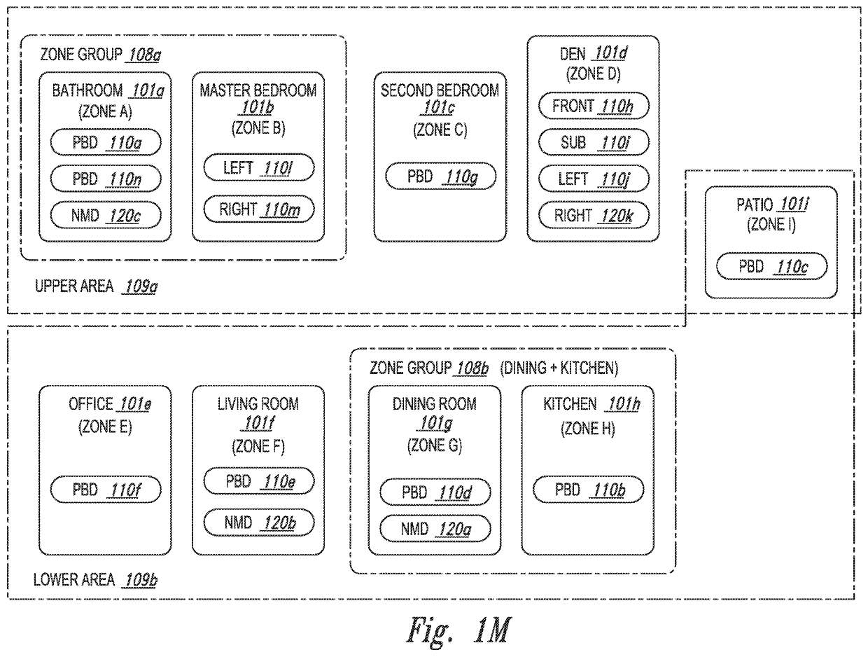

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles, and other features shown in the Figures are merely illustrative of particular embodiments of the disclosed technology. Accordingly, other embodiments can have other details, dimensions, angles, and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices 120 (“NMDs”) (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term “NMD” (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa). In some instances, such a playback device may be referred to as an NMD-enabled playback device.

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices, etc.) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation, etc.). In some embodiments, for example, the media playback system 100 is configured to play back audio from a first playback device (e.g., the playback device 110a) in synchrony with a second playback device (e.g., the playback device 110b). Interactions between the playback devices 110, NMDs 120, and/or control devices 130 of the media playback system 100 configured in accordance with the various embodiments of the disclosure are described in greater detail below with respect to FIGS. 1B-3F.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane, etc.), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed, to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some aspects, a single playback zone may include multiple rooms or spaces. In certain aspects, a single room or space may include multiple playback zones.

In the illustrated embodiment of FIG. 1A, the second bedroom 101c, the office 101e, the living room 101f, the dining room 101g, the kitchen 101h, and the outdoor patio 101i each include one playback device 110, and the master bathroom 101a, the master bedroom 101b and the den 101d include a plurality of playback devices 110. In the master bedroom 101b, the playback devices 1101 and 110m may be configured, for example, to play back audio content in synchrony as individual ones of playback devices 110, as a bonded playback zone, as a consolidated playback device, and/or any combination thereof. Similarly, in the den 101d, the playback devices 110h-k can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B, 1E, and 1I-1M.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication networks, and/or other suitable data transmission protocol networks), etc. The cloud network 102 is configured to deliver media content (e.g., audio content, video content, photographs, social media content, etc.) to the media playback system 100 in response to a request transmitted from the media playback system 100 via the links 103. In some embodiments, the cloud network 102 is further configured to receive data (e.g., voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WI-FI network, a BLUETOOTH network, a Z-WAVE network, a ZIGBEE network, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WI-FI” can refer to several different communication protocols including, for example, Institute of Electrical and Electronics Engineers (IEEE) 802.11a, 802.11b, 802.11g, 802.11n, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHz, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household or commercial facility communication network (e.g., a household or commercial facility WI-FI network). In some embodiments, the links 103 and the network 104 comprise one or more of the same networks. In some aspects, for example, the links 103 and the network 104 comprise a telecommunication network (e.g., an LTE network, a 5G network, etc.). Moreover, in some embodiments, the media playback system 100 is implemented without the network 104, and devices comprising the media playback system 100 can communicate with each other, for example, via one or more direct connections, PANs, telecommunication networks, and/or other suitable communication links. The network 104 may be referred to herein as a “local communication network” to differentiate the network 104 from the cloud network 102 that couples the media playback system 100 to remote devices, such as cloud servers that host cloud services.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length, etc.) and other associated information (e.g., URIs, URLs, etc.) for each identifiable media item found. In some embodiments, for example, the media content database is stored on one or more of the playback devices 110, network microphone devices 120, and/or control devices 130.

In the illustrated embodiment of FIG. 1B, the playback devices 1101 and 110m comprise a group 107a. The playback devices 1101 and 110m can be positioned in different rooms and be grouped together in the group 107a on a temporary or permanent basis based on user input received at the control device 130a and/or another control device 130 in the media playback system 100. When arranged in the group 107a, the playback devices 1101 and 110m can be configured to play back the same or similar audio content in synchrony from one or more audio content sources. In certain embodiments, for example, the group 107a comprises a bonded zone in which the playback devices 1101 and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110. Additional details regarding groups and other arrangements of playback devices are described in further detail below with respect to FIGS. 1I through 1M.

The media playback system 100 includes the NMDs 120a and 120b, each comprising one or more microphones configured to receive voice utterances from a user. In the illustrated embodiment of FIG. 1B, the NMD 120a is a standalone device and the NMD 120b is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) facilitate one or more operations on behalf of the media playback system 100.

In some aspects, for example, the computing device 106c comprises one or more modules and/or servers of a VAS (e.g., a VAS operated by one or more of SONOS, AMAZON, GOOGLE, APPLE, MICROSOFT, etc.). The computing device 106c can receive the voice input data from the NMD 120a via the network 104 and the links 103.

In response to receiving the voice input data, the computing device 106c processes the voice input data (i.e., “Play Hey Jude by The Beatles”), and determines that the processed voice input includes a command to play a song (e.g., “Hey Jude”). In some embodiments, after processing the voice input, the computing device 106c accordingly transmits commands to the media playback system 100 to play back “Hey Jude” by the Beatles from a suitable media service (e.g., via one or more of the computing devices 106) on one or more of the playback devices 110. In other embodiments, the computing device 106c may be configured to interface with media services on behalf of the media playback system 100. In such embodiments, after processing the voice input, instead of the computing device 106c transmitting commands to the media playback system 100 causing the media playback system 100 to retrieve the requested media from a suitable media service, the computing device 106c itself causes a suitable media service to provide the requested media to the media playback system 100 in accordance with the user's voice utterance.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WI-FI, BLUETOOTH, or another suitable communication link. In certain embodiments, the analog I/O 111a and the digital I/O 111b comprise interfaces (e.g., ports, plugs, jacks, etc.) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a BLUETOOTH connection, an ad hoc wired or wireless communication network, and/or another suitable communication link). The local audio source 105 can comprise, for example, a mobile device (e.g., a smartphone, a tablet, a laptop computer, etc.) or another suitable audio component (e.g., a television, a desktop computer, an amplifier, a phonograph (such as an LP turntable), a Blu-ray player, a memory storing digital media files, etc.). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens, etc.), and one or more transducers 114 (referred to hereinafter as “the transducers 114”). The electronics 112 are configured to receive audio from an audio source (e.g., the local audio source 105) via the input/output 111 or one or more of the computing devices 106a-c via the network 104 (FIG. 1B), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases, etc.).

The processors 112a can comprise clock-driven computing component(s) configured to process data, and the memory 112b can comprise a computer-readable medium (e.g., a tangible, non-transitory computer-readable medium loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone, etc.).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds, etc.) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receive and process the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WI-FI, BLUETOOTH, LTE, etc.). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 exclude the network interface 112d altogether and transmit and receive media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DACs), audio preprocessing components, audio enhancement components, digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omit the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers 112h include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G amplifiers, class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 include a single one of the amplifiers 112h configured to output amplified audio signals to a plurality of the transducers 114. In some other embodiments, the electronics 112 omit the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, Sonos, Inc. presently offers (or has offered) for sale certain playback devices including, for example, a “SONOS ONE,” “PLAY: 1,” “PLAY: 3,” “PLAY: 5,” “PLAYBAR,” “PLAYBASE,” “CONNECT: AMP,” “CONNECT,” “AMP,” “PORT,” and “SUB.” Other suitable playback devices may additionally or alternatively be used to implement the playback devices of example embodiments disclosed herein. Additionally, one of ordinary skill in the art will appreciate that a playback device is not limited to the examples described herein or to Sonos product offerings. In some embodiments, for example, one or more playback devices 110 comprise wired or wireless headphones (e.g., over-the-ear headphones, on-ear headphones, in-ear earphones, etc.). In other embodiments, one or more of the playback devices 110 comprise a docking station and/or an interface configured to interact with a docking station for personal mobile media playback devices. In certain embodiments, a playback device may be integral to another device or component such as a television, an LP turntable, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

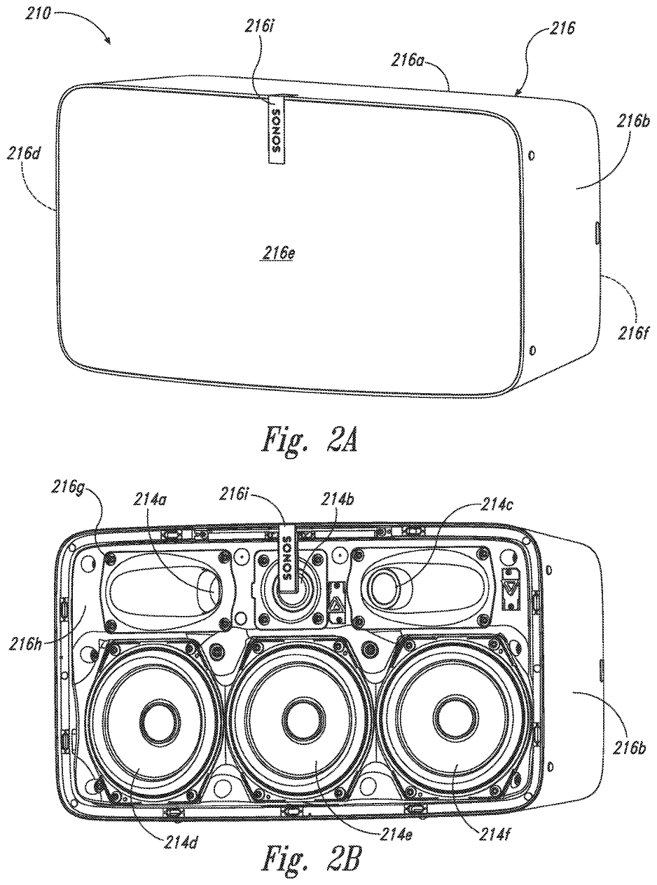

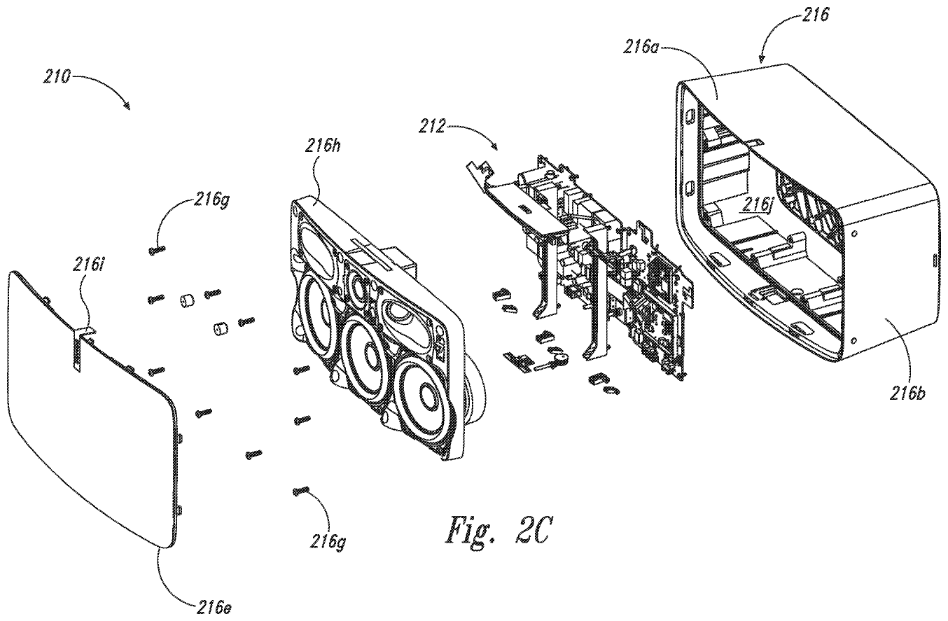

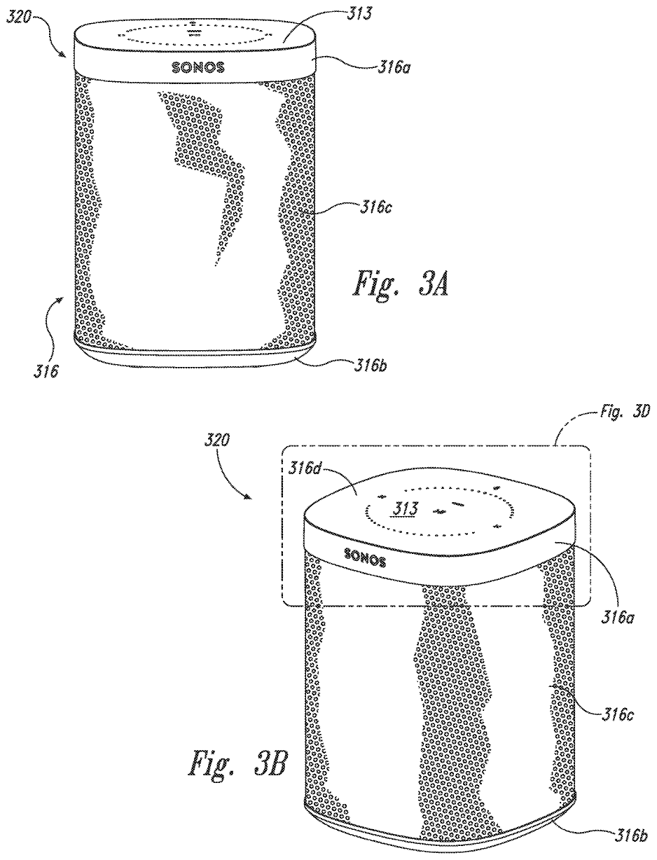

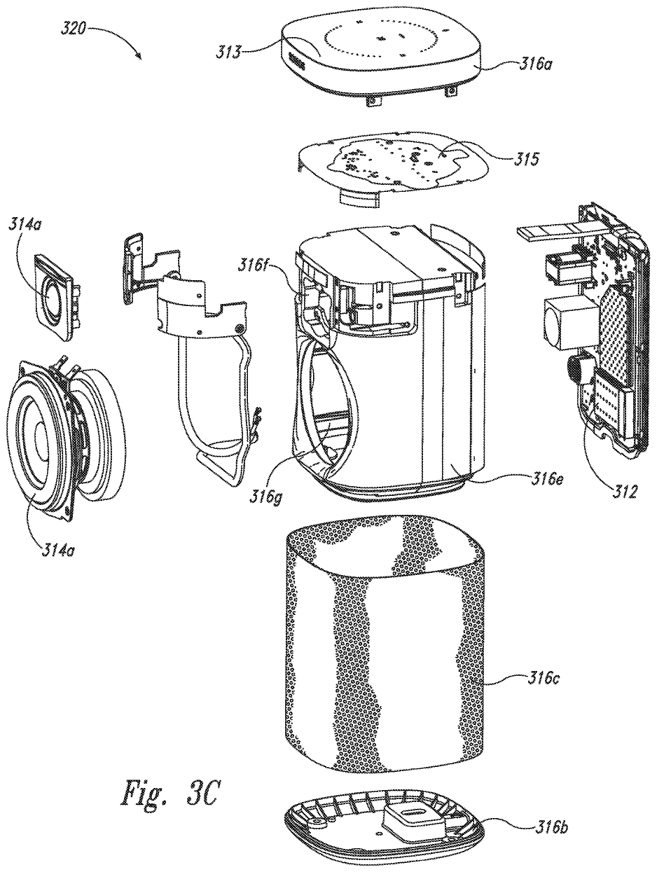

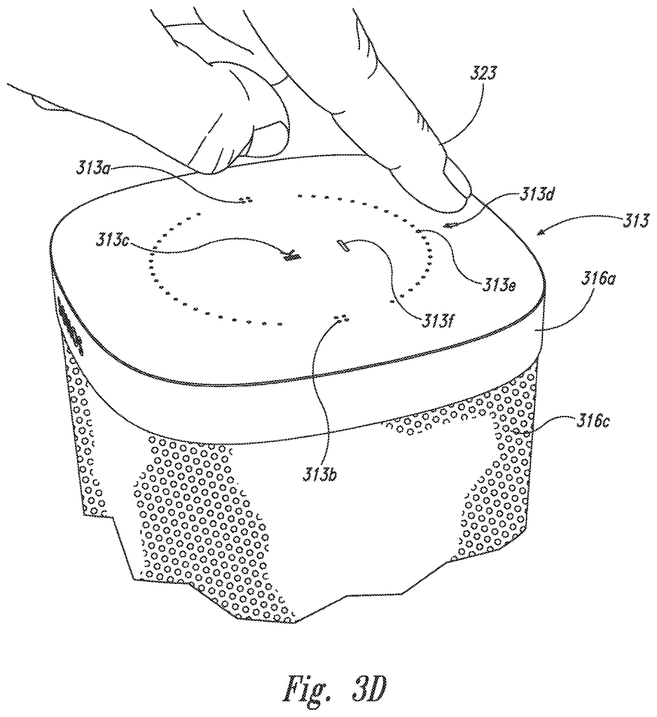

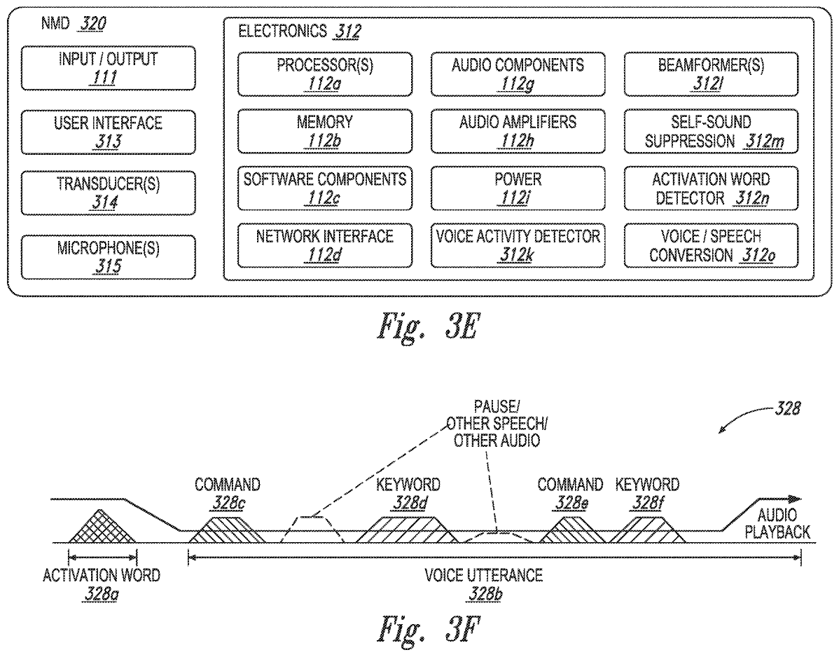

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 1101 and 110m of FIG. 1B). In some embodiments, for example, the playback device 110a is a full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device. Additional playback device embodiments are described in further detail below with respect to FIGS. 2A-3D.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio components 112g (FIG. 1C), the amplifiers 112h, and/or other playback device components. In certain embodiments, the NMD 120a comprises an Internet of Things (IOT) device such as, for example, a thermostat, alarm panel, fire and/or smoke detector, etc. In some embodiments, the NMD 120a comprises the microphones 115, the voice processing components 124, and only a portion of the components of the electronics 112 described above with respect to FIG. 1C. In some aspects, for example, the NMD 120a includes the processor 112a and the memory 112b (FIG. 1C), while omitting one or more other components of the electronics 112. In some embodiments, the NMD 120a includes additional components (e.g., one or more sensors, cameras, thermometers, barometers, hygrometers, etc.).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing components 124 (FIG. 1F). The playback device 110r optionally includes an integrated control device 130c. The control device 130c can comprise, for example, a user interface (e.g., the user interface 113 of FIG. 1C) configured to receive user input (e.g., touch input, voice input, etc.) without a separate control device. In other embodiments, however, the playback device 110r receives commands from another control device (e.g., the control device 130a of FIG. 1B). Additional NMD embodiments are described in further detail below with respect to FIGS. 3A-3F.

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing components 124 receive and analyze the microphone data to determine whether a voice input is present in the microphone data. The voice input can comprise, for example, an activation word followed by an utterance including a user request. As those of ordinary skill in the art will appreciate, an activation word is a word or other audio cue signifying a user voice input. For instance, in querying the AMAZON VAS, a user might speak the activation word “Alexa.” Other examples include “Ok, Google” for invoking the GOOGLE VAS and “Hey, Siri” for invoking the APPLE VAS.

After detecting the activation word, voice processing components 124 monitor the microphone data for an accompanying user request in the voice input. The user request may include, for example, a command to control a third-party device, such as a thermostat (e.g., NEST thermostat), an illumination device (e.g., a PHILIPS HUE lighting device), or a media playback device (e.g., a SONOS playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home. Additional description regarding receiving and processing voice input data can be found in further detail below with respect to FIGS. 3A-3F.

### D. Suitable Control Devices

FIG. 1H is a partial schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™, an Android phone, etc.) on which media playback system controller application software is installed. In some embodiments, the control device 130a comprises, for example, a tablet (e.g., an iPad) , a computer (e.g., a laptop computer, a desktop computer, etc.), and/or another suitable device (e.g., a television, an automobile audio head unit, an IoT device, etc.). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 132a to perform those functions. The software components 132c can comprise applications and/or other executable software configured to facilitate control of the media playback system 100. The memory 132b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE, etc.). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection, etc.) from the control device 130a to one or more of the playback devices 110. The network interface 132d can also transmit and/or receive configuration changes such as, for example, adding/removing one or more playback devices 110 to/from a zone, adding/removing one or more zones to/from a zone group, forming a bonded or consolidated player, separating one or more playback devices from a bonded or consolidated player, among others. Additional description of zones and groups can be found below with respect to FIGS. 1I through 1M.

The user interface 133 is configured to receive user input and can facilitate control of the media playback system 100. The user interface 133 includes media content art 133a (e.g., album art, lyrics, videos, etc.), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year, etc.) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone, etc.). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound, etc.) and/or configured to facilitate filtering of background noise. Moreover, in certain embodiments, the control device 130a is configured to operate as a playback device and an NMD. In other embodiments, however, the control device 130a omits the one or more speakers 134 and/or the one or more microphones 135. For instance, the control device 130a may comprise a device (e.g., a thermostat, an IoT device, a network device, etc.) comprising a portion of the electronics 132 and the user interface 133 (e.g., a touch screen) without any speakers or microphones.

e. Suitable Playback Device Configurations

FIGS. 1I through 1M show example configurations of playback devices in zones and zone groups. Referring first to FIG. 1M, in one example, a single playback device may belong to a zone. For example, the playback device 110g in the second bedroom 101c (FIG. 1A) may belong to Zone C. In some implementations described below, multiple playback devices may be “bonded” to form a “bonded pair” which together form a single zone. For example, the playback device 1101 (e.g., a left playback device) can be bonded to the playback device 110m (e.g., a right playback device) to form Zone B. Bonded playback devices may have different playback responsibilities (e.g., channel responsibilities). In another implementation described below, multiple playback devices may be merged to form a single zone. For example, the playback device 110h (e.g., a front playback device) may be merged with the playback device 110i (e.g., a subwoofer), and the playback devices 110j and 110k (e.g., left and right surround speakers, respectively) to form a single Zone D. In another example, the playback devices 110b and 110d can be merged to form a merged group or a zone group 108b. The merged playback devices 110b and 110d may not be specifically assigned different playback responsibilities. That is, the merged playback devices 110b and 110d may, aside from playing audio content in synchrony, each play audio content as they would if they were not merged.

Each zone in the media playback system 100 may be provided for control as a single user interface (UI) entity. For example, Zone A may be provided as a single entity named Master Bathroom. Zone B may be provided as a single entity named Master Bedroom. Zone C may be provided as a single entity named Second Bedroom.

Playback devices that are bonded may have different playback responsibilities, such as responsibilities for certain audio channels. For example, as shown in FIG. 1I, the playback devices 1101 and 110m may be bonded so as to produce or enhance a stereo effect of audio content. In this example, the playback device 1101 may be configured to play a left channel audio component, while the playback device 110m may be configured to play a right channel audio component. In some implementations, such stereo bonding may be referred to as “pairing.”

Additionally, bonded playback devices may have additional and/or different respective speaker drivers. As shown in FIG. 1J, the playback device 110h named Front may be bonded with the playback device 110i named SUB. The Front device 110h can be configured to render a range of mid to high frequencies and the SUB device 110i can be configured to render low frequencies. When unbonded, however, the Front device 110h can be configured to render a full range of frequencies. As another example, FIG. 1K shows the Front and SUB devices 110h and 110i further bonded with Left and Right playback devices 110j and 110k, respectively. In some implementations, the Left and Right devices 110j and 110k can be configured to form surround or “satellite” channels of a home theater system. The bonded playback devices 110h, 110i, 110j, and 110k may form a single Zone D (FIG. 1M).

Playback devices that are merged may not have assigned playback responsibilities, and may each render the full range of audio content the respective playback device is capable of. Nevertheless, merged devices may be represented as a single UI entity (i.e., a zone, as discussed above). For instance, the playback devices 110a and 110n in the master bathroom have the single UI entity of Zone A. In one embodiment, the playback devices 110a and 110n may each output the full range of audio content each respective playback devices 110a and 110n are capable of, in synchrony.

In some embodiments, an NMD is bonded or merged with another device so as to form a zone. For example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in subsequently referenced U.S. Pat. No. 10,499,146.

Zones of individual, bonded, and/or merged devices may be grouped to form a zone group. For example, referring to FIG. 1M, Zone A may be grouped with Zone B to form a zone group 108a that includes the two zones. Similarly, Zone G may be grouped with Zone H to form the zone group 108b. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zones in an environment may be the default name of a zone within the group or a combination of the names of the zones within a zone group. For example, Zone Group 108b can be assigned a name such as “Dining +Kitchen”, as shown in FIG. 1M. In some embodiments, a zone group may be given a unique name selected by a user.

Certain data may be stored in a memory of a playback device (e.g., the memory 112b of FIG. 1C) as one or more state variables that are periodically updated and used to describe the state of a playback zone, the playback device(s), and/or a zone group associated therewith. The memory may also include the data associated with the state of the other devices of the media system, and shared from time to time among the devices so that one or more of the devices have the most recent data associated with the system.

In some embodiments, the memory may store instances of various variable types associated with the states. Variable instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, identifiers associated with the second bedroom 101c may indicate that the playback device is the only playback device of the Zone C and not in a zone group. Identifiers associated with the Den may indicate that the Den is not grouped with other zones but includes bonded playback devices 110h-110k. Identifiers associated with the Dining Room may indicate that the Dining Room is part of the Dining +Kitchen zone group 108b and that devices 110b and 110d are grouped (FIG. 1L). Identifiers associated with the Kitchen may indicate the same or similar information by virtue of the Kitchen being part of the Dining +Kitchen zone group 108b. Other example zone variables and identifiers are described below.

In yet another example, the memory may store variables or identifiers representing other associations of zones and zone groups, such as identifiers associated with Areas, as shown in FIG. 1M. An area may involve a cluster of zone groups and/or zones not within a zone group. For instance, FIG. 1M shows an Upper Area 109a including Zones A-D and I, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. Pat. No. 10,712,997 filed Aug. 21, 2017, and titled “Room Association Based on Name,” and U.S. Pat. No. 8,483,853 filed Sep. 11, 2007, and titled “Controlling and manipulating groupings in a multi-zone media system.” Each of these patents is incorporated herein by reference in its entirety. In some embodiments, the media playback system 100 may not implement Areas, in which case the system may not store variables associated with Areas.

### III. Example Systems and Devices

FIG. 2A is a front isometric view of a playback device 210 configured in accordance with aspects of the disclosed technology. FIG. 2B is a front isometric view of the playback device 210 without a grille 216e. FIG. 2C is an exploded view of the playback device 210. Referring to FIGS. 2A-2C together, the playback device 210 comprises a housing 216 that includes an upper portion 216a, a right or first side portion 216b, a lower portion, a left or second side portion 216d, the grille 216e, and a rear portion 216f. A plurality of fasteners 216g (e.g., one or more screws, rivets, clips) attaches a frame 216h to the housing 216. A cavity 216j (FIG. 2C) in the housing 216 is configured to receive the frame 216h and electronics 212. The frame 216h is configured to carry a plurality of transducers 214 (identified individually in FIG. 2B as transducers 214a-f). The electronics 212 (e.g., the electronics 112 of FIG. 1C) are configured to receive audio content from an audio source and send electrical signals corresponding to the audio content to the transducers 214 for playback.

The transducers 214 are configured to receive the electrical signals from the electronics 112, and further configured to convert the received electrical signals into audible sound during playback. For instance, the transducers 214a-c (e.g., tweeters) can be configured to output high frequency sound (e.g., sound waves having a frequency greater than about 2 kHz). The transducers 214d-f (e.g., mid-woofers, woofers, midrange speakers) can be configured output sound at frequencies lower than the transducers 214a-c (e.g., sound waves having a frequency lower than about 2 kHz). In some embodiments, the playback device 210 includes a number of transducers different than those illustrated in FIGS. 2A-2C. For example, as described in further detail below with respect to FIGS. 3A-3C, the playback device 210 can include fewer than six transducers (e.g., one, two, three). In other embodiments, however, the playback device 210 includes more than six transducers (e.g., nine, ten). Moreover, in some embodiments, all or a portion of the transducers 214 are configured to operate as a phased array to desirably adjust (e.g., narrow or widen) a radiation pattern of the transducers 214, thereby altering a user's perception of the sound emitted from the playback device 210.

In some examples, a filter is axially aligned with the transducer 214b. The filter can be configured to desirably attenuate a predetermined range of frequencies that the transducer 214b outputs to improve sound quality and a perceived sound stage output collectively by the transducers 214. In some embodiments, however, the playback device 210 omits the filter. In other embodiments, the playback device 210 includes one or more additional filters aligned with the transducers 214b and/or at least another of the transducers 214.

FIGS. 3A and 3B are front and right isometric side views, respectively, of an NMD 320 configured in accordance with embodiments of the disclosed technology. FIG. 3C is an exploded view of the NMD 320. FIG. 3D is an enlarged view of a portion of FIG. 3B including a user interface 313 of the NMD 320. Referring first to FIGS. 3A-3C, the NMD 320 includes a housing 316 comprising an upper portion 316a, a lower portion 316b and an intermediate portion 316c (e.g., a grille). A plurality of ports, holes or apertures 316d in the upper portion 316a allow sound to pass through to one or more microphones 315 (FIG. 3C) positioned within the housing 316. The one or more microphones 315 are configured to receive sound via the apertures 316d and produce electrical signals based on the received sound. In the illustrated embodiment, a frame 316e (FIG. 3C) of the housing 316 surrounds cavities 316f and 316g configured to house, respectively, a first transducer 314a (e.g., a tweeter) and a second transducer 314b (e.g., a mid-woofer, a midrange speaker, a woofer). In other embodiments, however, the NMD 320 includes a single transducer, or more than two (e.g., two, five, six) transducers. In certain embodiments, the NMD 320 omits the transducers 314a and 314b altogether.

Electronics 312 (FIG. 3C) includes components configured to drive the transducers 314a and 314b, and further configured to analyze audio data corresponding to the electrical signals produced by the one or more microphones 315. In some embodiments, for example, the electronics 312 comprises many or all of the components of the electronics 112 described above with respect to FIG. 1C. In certain embodiments, the electronics 312 includes components described above with respect to FIG. 1F such as, for example, the one or more processors 112a, the memory 112b, the software components 112c, the network interface 112d, etc. In some embodiments, the electronics 312 includes additional suitable components (e.g., proximity or other sensors).

Referring to FIG. 3D, the user interface 313 includes a plurality of control surfaces (e.g., buttons, knobs, capacitive surfaces) including a first control surface 313a (e.g., a previous control), a second control surface 313b (e.g., a next control), and a third control surface 313c (e.g., a play and/or pause control) that can be adjusted by a user 323. A fourth control surface 313d is configured to receive touch input corresponding to activation and deactivation of the one or microphones 315. A first indicator 313e (e.g., one or more light emitting diodes (LEDs) or another suitable illuminator) can be configured to illuminate only when the one or more microphones 315 are activated. A second indicator 313f (e.g., one or more LEDs) can be configured to remain solid during normal operation and to blink or otherwise change from solid to indicate a detection of voice activity. In some embodiments, the user interface 313 includes additional or fewer control surfaces and illuminators. In one embodiment, for example, the user interface 313 includes the first indicator 313e, omitting the second indicator 313f. Moreover, in certain embodiments, the NMD 320 comprises a playback device and a control device, and the user interface 313 comprises the user interface of the control device.

Referring to FIGS. 3A-3D together, the NMD 320 is configured to receive voice commands from one or more adjacent users via the one or more microphones 315. As described above with respect to FIG. 1B, the one or more microphones 315 can acquire, capture, or record sound in a vicinity (e.g., a region within 10 m or less of the NMD 320) and transmit electrical signals corresponding to the recorded sound to the electronics 312. The electronics 312 can process the electrical signals and can analyze the resulting audio data to determine a presence of one or more voice commands (e.g., one or more activation words). In some embodiments, for example, after detection of one or more suitable voice commands, the NMD 320 is configured to transmit a portion of the recorded audio data to another device and/or a remote server (e.g., one or more of the computing devices 106 of FIG. 1B) for further analysis. The remote server can analyze the audio data, determine an appropriate action based on the voice command, and transmit a message to the NMD 320 to perform the appropriate action. For instance, a user may speak “Sonos, play Michael Jackson.” The NMD 320 can, via the one or more microphones 315, record the user's voice utterance, determine the presence of a voice command, and transmit the audio data having the voice command to a remote server (e.g., one or more of the remote computing devices 106 of FIG. 1B, one or more servers of a VAS and/or another suitable service). The remote server can analyze the audio data and determine an action corresponding to the command. The remote server can then transmit a command to the NMD 320 to perform the determined action (e.g., play back audio content related to Michael Jackson). The NMD 320 can receive the command and play back the audio content related to Michael Jackson from a media content source. As described above with respect to FIG. 1B, suitable content sources can include a device or storage communicatively coupled to the NMD 320 via a LAN (e.g., the network 104 of FIG. 1B), a remote server (e.g., one or more of the remote computing devices 106 of FIG. 1B), etc. In certain embodiments, however, the NMD 320 determines and/or performs one or more actions corresponding to the one or more voice commands without intervention or involvement of an external device, computer, or server.

FIG. 3E is a functional block diagram showing additional features of the NMD 320 in accordance with aspects of the disclosure. The NMD 320 includes components configured to facilitate voice command capture including voice activity detector component(s) 312k, beam former components 312, acoustic echo cancellation (AEC) and/or self-sound suppression components 312m, activation word detector components 312n, and voice/speech conversion components 312o (e.g., voice-to-text and text-to-voice). In the illustrated embodiment of FIG. 3E, the foregoing components 312k-312o are shown as separate components. In some embodiments, however, one or more of the components 312k-312o are subcomponents of the processors 112a.

The beamforming and self-sound suppression components 312l and 312m are configured to detect an audio signal and determine aspects of voice input represented in the detected audio signal, such as the direction, amplitude, frequency spectrum, etc. The voice activity detector activity components 312k are operably coupled with the beamforming and AEC components 312l and 312m and are configured to determine a direction and/or directions from which voice activity is likely to have occurred in the detected audio signal. Potential speech directions can be identified by monitoring metrics which distinguish speech from other sounds. Such metrics can include, for example, energy within the speech band relative to background noise and entropy within the speech band, which is measure of spectral structure. As those of ordinary skill in the art will appreciate, speech typically has a lower entropy than most common background noise.

The activation word detector components 312n are configured to monitor and analyze received audio to determine if any activation words (e.g., wake words) are present in the received audio. The activation word detector components 312n may analyze the received audio using an activation word detection algorithm. If the activation word detector 312n detects an activation word, the NMD 320 may process voice input contained in the received audio. Example activation word detection algorithms accept audio as input and provide an indication of whether an activation word is present in the audio. Many first-and third-party activation word detection algorithms are known and commercially available. For instance, operators of a voice service may make their algorithm available for use in third-party devices. Alternatively, an algorithm may be trained to detect certain activation words. In some embodiments, the activation word detector 312n runs multiple activation word detection algorithms on the received audio simultaneously (or substantially simultaneously). As noted above, different voice services (e.g., AMAZON's ALEXA, APPLE's SIRI, or MICROSOFT's CORTANA) can each use a different activation word for invoking their respective voice service. To support multiple services, the activation word detector 312n may run the received audio through the activation word detection algorithm for each supported voice service in parallel.

The speech/text conversion components 3120 may facilitate processing by converting speech in the voice input to text. In some embodiments, the electronics 312 can include voice recognition software that is trained to a particular user or a particular set of users associated with a household. Such voice recognition software may implement voice-processing algorithms that are tuned to specific voice profile(s). Tuning to specific voice profiles may require less computationally intensive algorithms than traditional voice activity services, which typically sample from a broad base of users and diverse requests that are not targeted to media playback systems.

FIG. 3F is a schematic diagram of an example voice input 328 captured by the NMD 320 in accordance with aspects of the disclosure. The voice input 328 can include an activation word portion 328a and a voice utterance portion 328b. In some embodiments, the activation word 328a can be a known activation word, such as “Alexa,” which is associated with AMAZON's ALEXA. In other embodiments, however, the voice input 328 may not include an activation word. In some embodiments, a network microphone device may output an audible and/or visible response upon detection of the activation word portion 328a. In addition, or alternately, an NMD may output an audible and/or visible response after processing a voice input and/or a series of voice inputs.

The voice utterance portion 328b may include, for example, one or more spoken commands (identified individually as a first command 328c and a second command 328e) and one or more spoken keywords (identified individually as a first keyword 328d and a second keyword 328f). In one example, the first command 328c can be a command to play music, such as a specific song, album, playlist, etc. In this example, the keywords may be one or words identifying one or more zones in which the music is to be played, such as the Living Room and the Dining Room shown in FIG. 1A. In some examples, the voice utterance portion 328b can include other information, such as detected pauses (e.g., periods of non-speech) between words spoken by a user, as shown in FIG. 3F. The pauses may demarcate the locations of separate commands, keywords, or other information spoke by the user within the voice utterance portion 328b.

In some embodiments, the media playback system 100 is configured to temporarily reduce the volume of audio content that it is playing while detecting the activation word portion 328a. The media playback system 100 may restore the volume after processing the voice input 328, as shown in FIG. 3F. Such a process can be referred to as ducking, examples of which are disclosed in U.S. Pat. No. 10,499,146, which is incorporated by reference herein in its entirety.

### IV. Example Power-Saving Methods and Apparatus

As discussed above, it is desirable to reduce the energy consumption of devices in a media playback system without negatively impacting the user's listening experience. To this end, aspects and embodiments provide power-saving techniques that enable one or more first playback devices to enter a suspended state in which various electronic components are powered down (e.g., turned off or disabled) such that the first playback device(s) significantly reduce power consumption while in the suspended state. One or more other (second) playback devices in the media playback system monitor for conditions, such as user input or scheduled events, for example, that indicate that one or more of the first playback devices in the suspended state should be “awakened” or caused to exit the suspended state and resume normal operations. Upon detection of such a condition, at least one of the monitoring/second playback devices can instruct or cause the suspended/first playback device(s) to exit the suspended state. In some examples, these “wake” instructions are given in conjunction with instructions for the first playback device(s) to begin synchronous playback of audio content with the playback device sending the instructions and/or one or more second playback devices, as discussed in more detail below.

In a media playback system, such as the media playback system 100 discussed above, at certain times, one or more playback devices 110 may be playing back audio content (referred to herein as being “in use”), either alone or in synchrony with one or more other playback devices 110, as discussed above; however, one or more other playback devices 110 may be idle (e.g., not playing back audio content). At times, all playback devices 110 in the media playback system 100 may be idle. Idle playback devices 110 offer convenient opportunities to employ power-saving techniques without disrupting the user's listening experience. Accordingly, certain aspects and embodiments are directed to identifying idle playback devices, determining whether the idle playback devices can, or should, be put into a suspended state to reduce their power consumption, and causing the idle playback devices, where appropriate, to enter the suspended state. As used herein, an “active” playback device is one that is not in the suspended state. An active playback device may be idle or in use.

In certain examples, when a playback device 110 enters the suspended state, one or more of its processors (e.g., processors 112a discussed above) and/or software components 112c are disabled to save power. Accordingly, the playback device 110 can be configured and/or programmed in a manner that enables this “turning off” of certain components and functionality, while retaining the ability to detect the wake instructions and re-activate the disabled components to resume normal operations.

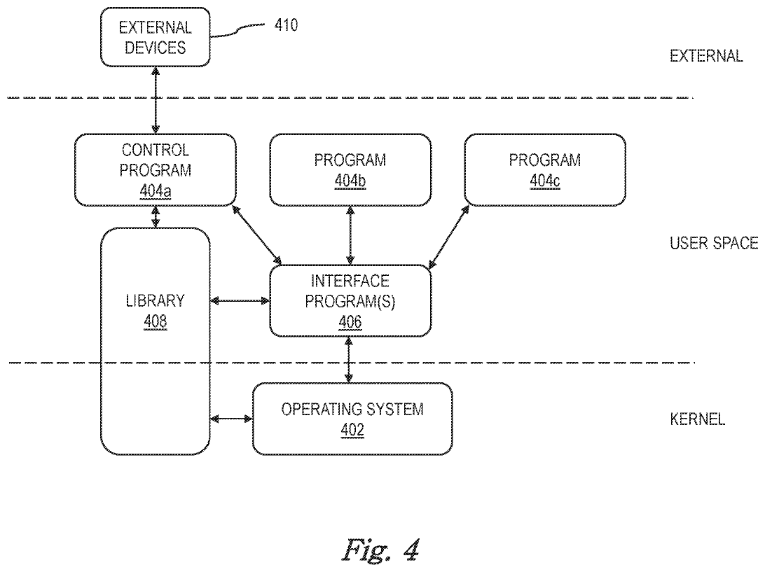

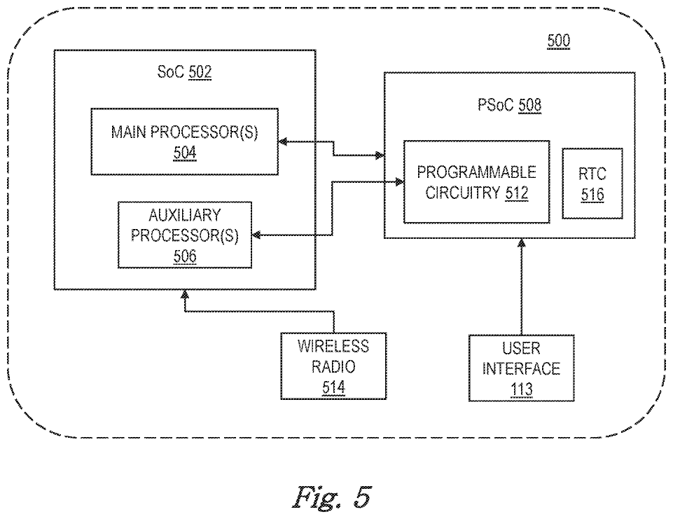

Referring to FIG. 4, in examples, a playback device 110 includes a plurality of software components, such as the software components 112c discussed above, that can be executed by one or more processors, such as the processor(s) 112a discussed above, to manage and implement various functionality of the playback device. For example, as shown in FIG. 4, the software components include an operating system 402, along with various user space programs 404a, 404b, 404c (collectively 404) and 406. By way of illustration, program 404a is a control program that configures the playback device 110 to play back audio via the one or more speakers (e.g., transduces 114) and the one or more amplifiers 112h. Accordingly, the control program 404a may be in communication with one or more external devices 410 (such as one or more other playback devices 110, control devices 130, or computing devices 106) to obtain audio content for playback, for example. Program 404b is a network and connection manager configured to manage wired and/or wireless connections via the network interface 112d. Program 404c is an upgrade manager configured to manage upgrades to the software components 112c of the portable playback device 110. These programs 404 are shown by way of example, and other implementations may include additional or fewer programs 404, as well as programs 404 that are responsible for different device functions.

In examples, the program 406 includes one or more power control programs that are configured to coordinate between the other user-space programs 404 and the operating system 402. The power control program(s) 406 may include a power management program that coordinates various aspects of configuring the playback device 110 into and out of the suspended state based on detecting corresponding sleep/suspend and wake/resume commands. In other examples, the programs 404 may communicate directly with the operating system 402 without interoperating with the power control program(s) 406 for coordination. The software components may further include a system library 408. The system library 408 provides the power control program(s) 406 with access to kernel functions, such as suspend (which configures the playback device into the suspended state), using commands, function calls, protocols, and/or objects, which are collectively referred to herein as instructions. To access such functions, the power control program(s) 406 may make a function call to the appropriate function in the system library 408. In examples, certain user-space programs 404 (e.g., the control program 404a) have access to the system library 408. Such access facilitates communication with kernel drivers, which control hardware components of the playback device 110. For example, the control program 404a may have access to the system library 408 to control kernel drivers corresponding to the audio pipeline (e.g., the audio processing components 112g and audio amplifier(s) 112h).

In some examples, the suspended state includes a “kernel suspend,” during which the main processor(s) of the playback device 110 are suspended and the kernel and user-space programs 404, 406 are not executing, which reduces power consumption of the playback device 110. However, since these programs are not executing, they cannot perform their intended functions. Accordingly, the playback device 110 can be configured and/or controlled to enter the suspended state only when doing so will not disrupt a user's listening experience. For example, when the playback device is idle, one or more user-space programs 404, such as the control program 404a, may not be executing, and therefore preventing these programs from executing by entering the suspended state may not have any adverse effect. In some examples, certain user-space programs 404 may be classified as programs that cannot be interrupted (such as the control program 404a, for example), and therefore, the playback device 110 may be prevented from entering the suspended state while one or more of these programs are executing. Other user-space programs 404 may be classified as interruptible, such that the playback device 110 can enter the suspended state even if one or more of these other programs 404 is executing. In addition, since the operating system 402 and the user-space programs 404, 406 are not executing when the playback device 110 is in the suspended state, a mechanism is provided, external to the kernel and user-space programs, to enable the playback device to detect instructions or other triggers that indicate that the playback device 110 is to exit the suspended state (“kernel resume”) and resume normal operations. FIG. 5 illustrates an architecture that facilitates kernel resume based on any of a plurality of kernel resume triggers from different components.

Referring to FIG. 5, there is illustrated a block diagram showing an example of electronic circuitry 500 that may be included in playback devices 110 that are equipped with the capability to enter the suspended state (also referred to as “sleep capability”). The circuitry 500 may include or may be part of the electronics 112 discussed above with reference to FIGS. 1C-1F. As shown in FIG. 5, the circuitry 500 includes a system-on-chip (SoC) 502, which in some examples is an implementation of the processor(s) 112a of the playback device 110. The SoC 502 includes one or more main processor(s) 504 and one or more auxiliary processor(s) 506. In one example, the main processor 504 and the auxiliary processor 506 are implemented as separate cores on the SoC 502. The operating system 402 executes on the SoC 502, and various user-space programs (e.g., 404, 406) execute on top of the kernel. The SoC 502 may communicate with external devices via a wireless radio 514.

In examples, when the playback device 110 is in the suspended state, the main processor 504 is disabled. Accordingly, the operating system 402 and/or any user-space programs 404, 406 executing on the main processors 504 are also disabled. In examples, during the suspended state, the main processor 504 is power gated to reduce power usage, but the auxiliary processor 506 is kept active to receive signals that trigger a kernel resume to cause the playback device 110 to exit the suspended state. Any of a variety of signals may trigger a kernel resume, as discussed in more detail below. The main processor 504 is resumed by the auxiliary processor 506. For instance, detection of a particular signal by the auxiliary processor 506 may trigger execution of an interrupt service routine (ISR) that causes the main processor 504 to be resumed.

In the example illustrated in FIG. 5, the circuitry 500 includes a programmable system-on-chip (PSoC) 508, which is separately programmable from the SoC 502. However, in other examples, the PSoC 508 may be implemented as part of the SoC 502. The PSoC 508 includes various software and corresponding circuitry (identified collectively as programmable circuitry 512 in FIG. 5) configured to detect input data from various sources, such as the user interface 113. For example, as discussed above, the user interface 113 may include one or more capacitive touch portions that enable a user to provide instructions or commands to the playback device via a capacitive touch sensor. Thus, the programable circuitry 512 may include software and corresponding circuitry configured to receive input data from the capacitive touch portions of the user interface 113, interpret this data and generate corresponding commands, which are shared with the SoC 502 and ultimately the user-space programs 404 to control various functions. In some examples, the PSoC 508 includes a real-time clock (RTC) 516 that can be used to facilitate kernel resume events based on a schedule or other timing consideration, as discussed further below. The PSoC 508 may include other components as well.

The input data received by the PSoC 508 via the user interface 113 may include a kernel resume command (e.g., instructions or other input that indicates that the playback device 110 is to exit the suspended state). Accordingly, in some examples, when the playback device 110 is in the suspended state, the PSoC 508 remains active to generate kernel resume triggers (e.g., interrupts). For example, in some implementations, the programmable circuitry 512 generates a signal (e.g., an interrupt) when touch input is received via the user interface 113, which is sent to the auxiliary processor 506 to facilitate a wake-on-touch kernel resume event.

As another example, when a BLUETOOTH or WI-FI connection is made, the wireless radio 514 may generate a signal (e.g., an interrupt) that is sent to the auxiliary processor 506 to facilitate a wake-on-BLUETOOTH or wake-on-wireless kernel resume event. Various other kernel resume events can be processed by the circuitry 500 as well. For examples, as discussed further below, data containing instructions from another playback device to cause the playback device to exit the suspended state may be received over a wireless (e.g., BLUETOOTH, WI-FI, or other) connection via the wireless radio 514, and an appropriate kernel resume trigger may be generated by the wireless radio 514.

When the playback device 110 is active, it may detect instructions to enter the suspended state. In some examples, these instructions may be in the form of one or more messages received from another playback device in the media playback system (e.g., via the wireless radio 514). In other examples, these instructions may be based on a schedule, user input, or detection of a suspend condition/trigger by the playback device 110 itself, any of which may generate internal messages that can be passed among the software components 112c of the playback device 110 to configure the playback device into the suspended state. For example, referring again to FIG. 4, the power control program(s) 406 may generate and/or receive such messages, and send instructions to the operating system 402 using the system library 408 (e.g., by using a function call or command) to cause the playback device 110 to enter the suspended state. As noted above, in the suspended state, user-space programs, such as the control program 404a, are not executing and the main processor 504 is disabled. The playback device 110 may remain in the suspended state until a kernel resume trigger is detected. As discussed above, the kernel resume trigger may be based on a variety of inputs and/or conditions, such as a scheduled “wake” time, instructions received via one or more messages from another playback device, and/or user input, for example. In some examples, upon a kernel resume event, the system library 408 may record a source of the kernel resume trigger, which can be distributed to one or more of the user-space programs 404 by the interface program(s) 406. This allows the user-space programs 404 to modify their operation based on the source of the kernel resume trigger. For instance, if the source of the kernel resume trigger is a wake-on-BLUETOOTH trigger, the control program 404a may change the playback source to streaming via BLUETOOTH. Other examples are possible as well.

According to certain embodiments, one or more playback devices 110 may automatically enter the suspended state and schedule a resume time based on factors such as a user-programmed schedule (e.g., programmed by the user via a control device 130) or usage patterns. For example, the media playback system 100 may identify that one or more playback devices 110 typically are not in use at certain times (e.g., late at night, or during weekday business hours), and allow a user to schedule automatic suspend for the playback devices during these times. However, in some instances, there may be disadvantages associated with this approach. For example, it may require significant user intervention to set up the schedules. Further, depending on the architecture of the circuitry 500, certain functionality may not be available while the playback device 110 is in the suspended state, which may be disruptive to a user's experience, particularly in environments where multiple users interact with the same media playback system. Accordingly, aspects and embodiments provide power-saving techniques and approaches whereby one or more playback devices remain fully active and able to respond to user input at any time, while coordinating and controlling suspend conditions for other playback devices in the system. In this manner, power savings can be achieved by allowing one or more idle playback devices to enter the suspended state, while retaining the ability to automatically cause the suspended playback devices to resume normal operations when needed, without requiring a user to manually wake the suspended playback devices and without necessarily being restricted to a preset schedule.

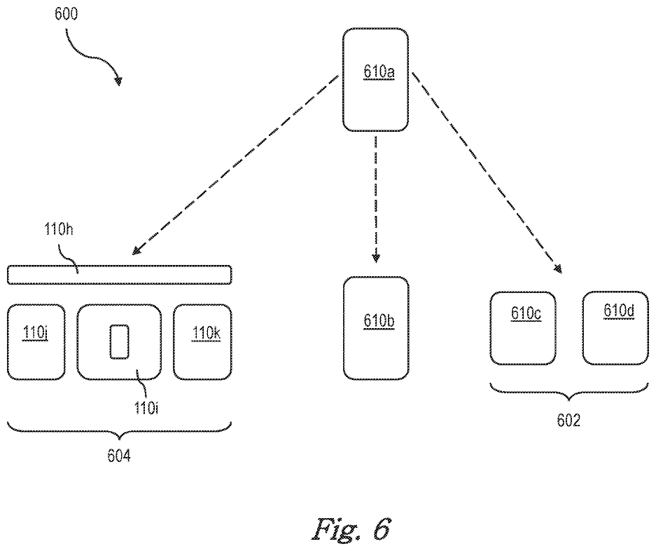

Referring to FIG. 6, there is illustrated an example of a media playback system 600 (such as an example of the media playback system 100 discussed above) configured to implement various power-saving techniques disclosed herein. In the illustrated example, the media playback system 600 includes a plurality of playback devices, including a first playback device 610a, a second playback device 610b, a bonded group 602 including playback devices 610c, 610d (e.g., a stereo pair such as discussed above with respect to FIG. 1I), and a home theater group 604 (e.g., as discussed above with respect to FIG. 1K). It will be appreciated that the example shown in FIG. 6 is illustrative only, and the media playback system 600 may include more or fewer playback devices in different configurations than as shown in FIG. 6.

According to certain embodiments, one (or more) of the playback devices in the media playback system 600 is identified as a manager playback device that coordinates suspend conditions for other playback devices in the media playback system 600, while remaining active itself. For the purposes of explanation and illustration, the following discussion refers to the playback device 610a as the manager device (“manager device 610a”); however, it will be appreciated that any one or more of the playback devices 610b, 610c, 610d, 110i, 110j, 110k, and/or 110h may also or alternatively be configured as manager devices in other examples. The manager device may be a stand-alone playback device (or NMD or other device in the media playback system) or may be part of a bonded group (e.g., group 602 or 604). The manager device 610a may or may not have sleep capability itself. In examples, the manager device 610a may be selected based on certain functionality and/or capabilities. For example, it may be preferable to select an NMD-enabled playback device as the manager device 610a, such that the manager device can respond to voice commands that may be received while others of the playback devices in the media playback system 600 are in the suspended state.

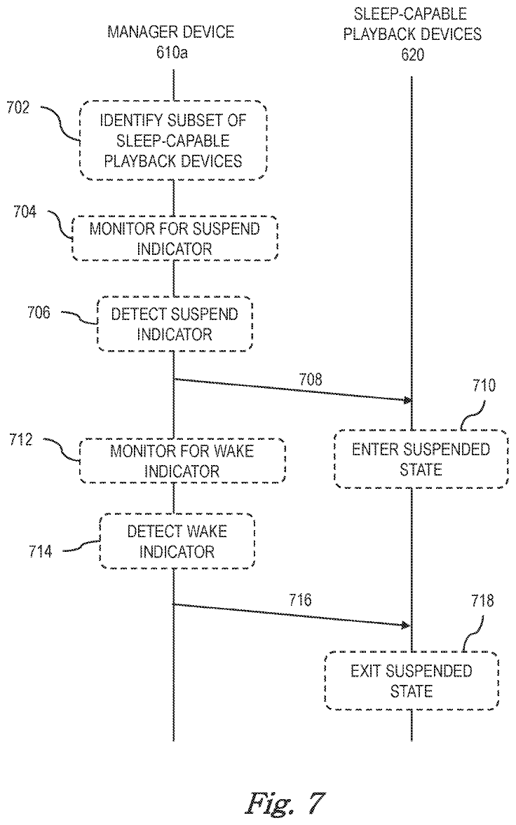

Referring to FIG. 7, there is illustrated a sequence diagram of one example of a method of power management according to certain aspects. In this example, the media playback system 600 includes one or more sleep-capable playback devices 620, which may be any of the playback devices 610b, 610c, 610d, 110i, 110j, 110k, and/or 110h. As discussed above, sleep-capable playback devices 620 include those having the circuitry 500, or similar circuitry, that enables the main processor 504 and software programs executing thereon to be suspended, while maintaining at least one auxiliary processor 506 in an active state to monitor for and receive wake instructions. At least some of the sleep-capable playback devices 620 may be always-powered devices. In some examples, the media playback system identifies a subset of playback devices in the system that are sleep-capable playback devices 620. The subset may include all the playback devices in the media playback system 600 or fewer than all the playback devices. The system also identifies/selects the manager device 610a, as discussed above. In some examples, the manager device 610 identifies the subset of sleep-capable playback devices 620 at 702, as shown in FIG. 7; however, in other examples, this identification may be performed by one or more other devices in the media playback system.

At 704, the manager device 610a monitors for a suspend indicator (also referred to herein as a sleep indicator). As discussed above, the suspend indicator may correspond to any of a variety of conditions or events. In some examples, the suspend indicator corresponds to one or more of the sleep-capable playback devices having been idle (e.g., the control program 404a has not received a command to play back audio content) for a specified time period. Accordingly, in such examples, the manager device 610a may determine that one or more of the sleep-capable playback devices 620 has not received, for the specified time period, control information that instructs that device to play back audio content. This determination may be made by monitoring messaging occurring within the media playback system 600 or by receiving information from the idle playback device(s). For example, the control program 404a may determine that the corresponding playback device is ready to enter the suspended state when no commands to play back audio content have been received for a certain duration, and may communicate a suspend-ready status of the idle playback device to the manager device 610a. In other examples, the suspend indicator may be based on a preset suspend/sleep schedule that has been set up in the media playback system 600, for example, by a user. For example, the manager device 610a may determine, using the real-time clock 516 or another system clock, that a preset sleep time in the sleep schedule has been reached, or is approaching, for one or more of the sleep-capable playback devices 620. In another example, the suspend indicator may be based on a user input received via the user interface 113 (or via the microphones 115 in the case of a voice input) of the manager device 610a or another device in the media playback system 600 that communicates the user input to the manager device 610a. For example, a user may instruct the media playback system 600 to cause one or more of the sleep-capable playback devices 620 to enter the suspended state.

Upon detecting the suspend indicator at 706, the manager device 610a sends instructions 708, via communication of one or more messages, to one or more of the sleep-capable playback devices 620 to cause the one or more sleep-capable playback devices 620 to enter the suspended state at 710. In examples, the one or more messages are communicated from the manager device 610 to the one or more sleep-capable playback devices 620 via their respective wireless radios 514. The messages may be sent using WI-FI, BLUETOOTH, or another suitable wireless communications technology and protocol.

At 710, the one or more sleep-capable playback devices 620 that detected the instructions from the manager device 610a enter the suspended state. As discussed above, in some examples, in the suspended state, the playback devices 620 suspend operation of the main processor 504 and execution of the operating system 402 and at least some of the user-space programs 404, 406, including the control program 404a.

While the one or more sleep-capable playback devices 620 are in the suspended state, the manager device 610a (which remains active) monitors for a wake/resume indicator at 712. The wake indicator may include any of a variety of conditions, events, or instructions from a user of the media playback system 600. In some examples, the wake indicator includes a command for one or more of the playback devices 620 in the suspended state to begin playback of audio content, optionally in synchrony with one or more other playback devices in the media playback system 600. In other examples, the wake indicator is based on the preset suspend/sleep schedule discussed above. For example, the manager device 610a may determine, using the real-time clock 516 or another system clock, that a preset wake/resume time in the sleep schedule has been reached, or is approaching, for one or more of the suspended playback devices 620.

Upon detection of the wake indicator at 714, the manager device 610a sends wake instructions 716, via communication of one or more messages, to one or more of the suspended playback devices 620 to cause the one or more suspended playback devices 620 to exit the suspended state at 718. In examples, the one or more messages are communicated from the manager device 610 to the one or more sleep-capable playback devices 620 via their respective wireless radios 514, as discussed above.

At 718, the one or more suspended playback devices 620 may detect the wake instructions via the auxiliary processor 506, as discussed above. The auxiliary processor 506 causes the main processor 504 to resume operation (“wake up”). Once the main processor 504 is active, the kernel resumes (e.g., the main processor 504 resumes executing the operating system 402). After the kernel is resumed, the user-space programs 404, 406 may be resumed as well. For example, where the wake indicator includes a command for a suspended playback device 620 to begin playing back audio content, once the main processor 504 is active and the operating system 402 is executing on the main processor, the control program 404a can be resumed to control the playback device to begin playback of the audio content. In some examples, the wake indicator includes a command for the suspended playback device(s) 620 to begin playing back audio content in synchrony with one or more other playback devices in the media playback system 600. In such cases, after exiting the suspended state, the playback device may wait to achieve sufficient time synchrony with the one or more other playback devices, and then begin playing back the audio content, as managed by the control program 404a. In some instances, achieving sufficient time synchrony includes achieving a clock difference error that is below a preset threshold for initiating playback without an echo. In other instances, achieving sufficient time synchrony includes exchanging timing information or otherwise determining clock offsets among the group of playback devices that are to play the audio content in synchrony and adjusting the audio stream (e.g., buffering) at one or more the playback devices such that the audio content can be played by the group without a noticeable difference (e.g., echo) from the perspective of an average human listener.

As discussed above, in certain examples, the suspend indicator and wake/resume indicator are based on “real-time” events or conditions, such as determining that one or more playback devices have been idle for some time or receiving a user command. In one example, where at least one suspended playback device is part of the home theater group 604, the wake indicator may include detecting that the user has turned on a television set coupled to the home theater group 604. In other examples, the suspend indicator and wake/resume indicator can be based on a preset schedule, as discussed above. It will be appreciated that different conditions may exist and be monitored for different sleep-capable playback devices 620 in the media playback system 600. Accordingly, the manager device 610a need not instruct all the sleep-capable playback devices 620 to suspend or resume at the same time. Rather, the manager device 610a can instruct different sleep-capable playback devices at different times based on applicable conditions. For example, a sleep schedule may be set up for the playback devices 610c, 610d in the group 602, but not for the playback device 610b. In other instances, the playback device 610b may have been idle for the predetermined time period, such that the manager device 610a detects the suspend indicator as it applies to the playback device 610b, but one or more of the other sleep-capable playback devices may be in use. Accordingly, the manager device 610a can instruct the idle playback device to enter the suspended state without interrupting or otherwise affecting the operation of the playback devices that are in use.

In addition, certain conditions may be “override” conditions that take precedence over other conditions. For example, the manager device 610a may cause one or more sleep-capable playback devices in the home theater group 604 to enter the suspended state based on a preset sleep schedule that is applicable to the home theater group (and optionally to one or more other sleep-capable playback devices 620). While the one or more sleep-capable playback devices in the home theater group 604 are in the suspended state, and before the scheduled wake-up time occurs, the manager device 610a may detect a user command to use the home theater group 604. For example, the user may turn on the associated television, as discussed above, or issue a command to begin playback of audio content on the home theater group. Such user commands can be classified as override commands that override the preset sleep schedule, such that the manager device 610a causes the relevant playback devices to exit the suspended state, regardless of the sleep schedule.

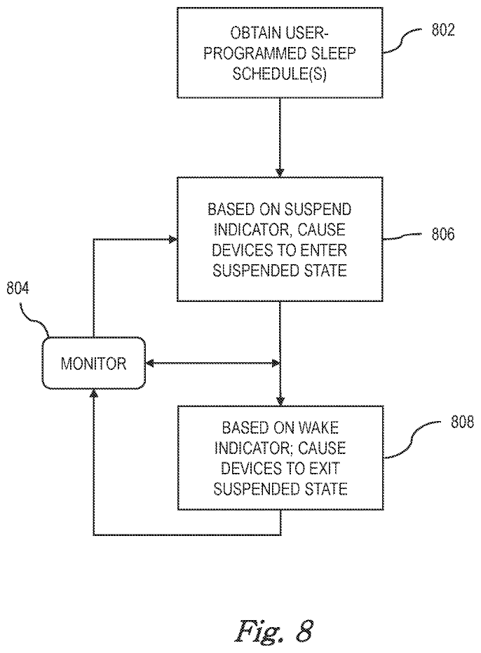

Referring to FIG. 8, there is illustrated a flow diagram of one example according to certain aspects disclosed herein. In some examples, the user may configure which playback devices in the media playback system 600 are to be scheduled to enter the suspended state at certain times (e.g., at night or during weekday business hours when the users may be away from home). Thus, at 802, the user may set or confirm one or more sleep schedule for one or more playback devices in the media playback system 600, and/or make modifications to one or more existing sleep schedules. The user may set up the sleep schedules using a control device 130, for example. Through the control device 130, the system may indicate which playback devices are sleep-capable and therefore available to be scheduled for sleep. Some users may choose to keep bedroom playback devices active throughout the night so that they can listed to white noise programs or maintain access to their voice assistant, for example, while selecting playback devices in common spaces (e.g., dining room or kitchen, for example) or secondary/guest bedrooms to enter the suspended state at night. Other users may make different selections based on preferences and/or privacy concerns, for example. Furthermore, different sleep schedules can be set up for different devices, as discussed above. Using a control device 130, for example, the user may adjust or modify sleep schedules at any time.

Once the sleep schedule(s) have been set up, at 804, the system monitors for suspend and resume indicators, as discussed above with reference to items 704 and 712 in FIG. 7. At 806, based on detection of a suspend indicator (scheduled or otherwise), the manager device 610a causes the relevant sleep-capable playback device(s) to enter the suspended state, as discussed above. Similarly, at 808, based on detection of a wake indicator (scheduled or otherwise), the manager device 610a causes the relevant suspended playback device(s) to exit the suspended state, as discussed above. Thus, examples of the media playback system provide a flexible, easy-to-use, and customizable approach to leverage the ability to place one or more playback devices into the suspended state to reduce energy consumption. The system and/or the user may identify at least one playback device; the manager device 610a; that remains active at all times to monitor for any wake/resume indicators that may occur while other playback devices are in the suspended state. In this way, the sleep/suspend capability of playback devices can be used for power-savings without compromising the ability of the media playback system 600 to respond at any time to user inputs. Further, the user has control over selecting which playback devices in the media playback system 600 may enter the suspended state, and when. However, the user may also allow the media playback system to autonomously monitor for real-time suspend indicators and configure sleep-capable playback devices into the suspended state when appropriate, without requiring user input. Thus, the system may allow the user control where such control is desired, but may also be able to act autonomously to reduce power consumption without compromising or otherwise negatively impacting the user's experience with the media playback system 600. In addition, as discussed above, in examples, the PSoC 508 in the circuitry 500 of sleep-capable playback devices remains operational in the suspended state and is coupled to the user interface 113. Accordingly, the user may override a sleep schedule or other condition that placed any sleep-capable playback device into the suspended state by accessing the user interface 113 (e.g., using a capacitive touch sensor or pressing a button) to cause the suspended playback device to wake and resume normal operations.

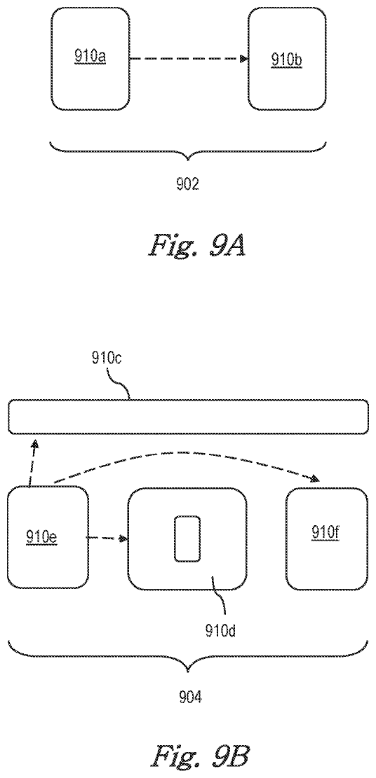

In examples discussed above, one or more manager devices 610a may coordinate configuring the sleep-capable playback devices 620 into and out of the suspended state across the entire media playback system 600. In further examples, power-saving techniques may be applied within a bonded group, such as a stereo pair or home theater group, for example, whether or not the techniques discussed above are applied to the media playback system 600 overall. FIGS. 9A and 9B illustrate examples of bonded groups (a stereo pair 902 in FIG. 9A and a home theater group 904 in FIG. 9B) in which there is at least one sleep-capable playback device and in which power-saving techniques may be applied in accord with aspects of the technology disclosed herein.

Referring to FIG. 9A, there is illustrated an example of a stereo pair 902, such as those discussed above with reference to FIGS. 1I and 6. The stereo pair 902 includes two bonded playback devices 910a and 910b, at least one of which is a sleep-capable playback device. According to certain examples, one of the two playback devices 910a, 910b is selected as a manager device that controls configuring the other playback device into and out of the suspended state, as discussed above, to reduce power consumption when the stereo pair 902 is idle. For the purposes of the following example, the playback device 910a is the manager device and the playback device 910b is a sleep-capable playback device. The manager device 910a may or may not be sleep-capable.

Similar to the examples of the manager device 610a discussed above, the manager device 910a may monitor for a suspend indicator, and upon detection of the suspend indicator, cause the other playback device 910b to enter the suspended state. In examples, the manager device 910a communicates one or more messages to the other playback device 910b, via the wireless radio 514, for example, to direct the other playback device to enter the suspended state. The messages are processed by the SoC 502 to configure the playback device into the suspended state, as discussed above. The manager device 910a remains active while the other playback device is in the suspended state, and monitors for a wake/resume indicator. Upon detection of the wake indicator, the manager device 910a causes the other playback device 910b to resume. For example, the manager device 910a may communicate one or more messages to the other playback device 910b, the messages being processed by the auxiliary processor 506, which can resume the main processor 504 as discussed above. After the main processor 504 is woken up, the kernel resumes, as discussed above, and the other playback device 910b becomes active and available to perform normal functions, including playing back audio content in synchrony with the manager device 910a.

Referring to FIG. 9B, there is illustrated an example of a home theater bonded group 904, such as those discussed above with reference to FIGS. 1K and 6. In the illustrated example, the home theater group 904 includes a primary device 910c, such as a soundbar, for example, and a plurality of satellite devices 910d, 910e, and 910f. As in the case of the stereo pair 902 discussed above, one of the playback devices in the home theater group may be selected as a manager device to coordinate power-saving techniques within the bonded group. The manager device may be selected based on any of several factors. For example, if some of the playback devices in the group 904 are sleep-capable and others are not, one of the playback devices that is not sleep-capable may be selected as the manager device because the manager device always remains active. In another example, if some of the playback devices in the group 904 have microphones and others do not, it may be preferable to select one of the playback devices with a microphone to act as the manager device, so as to preserve the ability of the bonded group 904 to respond to voice input while certain playback devices within the group are in the suspended state. This same consideration may be applied when selecting the manager device 910a in the stereo pair 902. In the example illustrated in FIG. 9B, the satellite device 910e is selected as the manager device; however, in other examples, another playback device (e.g., the primary playback device 910c) may be selected as the manager device.

The manager device 910e operates within the home theater bonded group 904 in the same manner as the manager device 910a in the stereo pair example discussed above. The manager device 910e monitors for a suspend indicator, and upon detection of the suspend indicator, causes the remaining sleep-capable playback devices in the home theater group to enter the suspended state. The manager device 910e remains active and monitors for a wake indicator. Upon detection of the wake indicator, the manager device 910e causes the suspended playback devices within the group 904 to resume.

In some instances, one or more of the playback devices in the home theater group 904 (or in another bonded group) may enter the suspended state independently of other sleep-capable devices in the group. For example, some users only use their soundbar 910c when watching television. Accordingly, when the television is turned off, the soundbar 910c may enter the suspended state, even if one or more of the satellite playback devices 910e, 910d, 910e that are sleep-capable remain active. In such instances, one of the active satellite devices can be selected as the manager device (e.g., playback device 910e) to monitor for a wake indicator that indicates that the soundbar 910c should exit the suspended state. In other examples, the soundbar 910c may independently monitor for a wake indicator, such as the television being turned on, for example, using the PSoC 508 and/or auxiliary processor 506 discussed above.

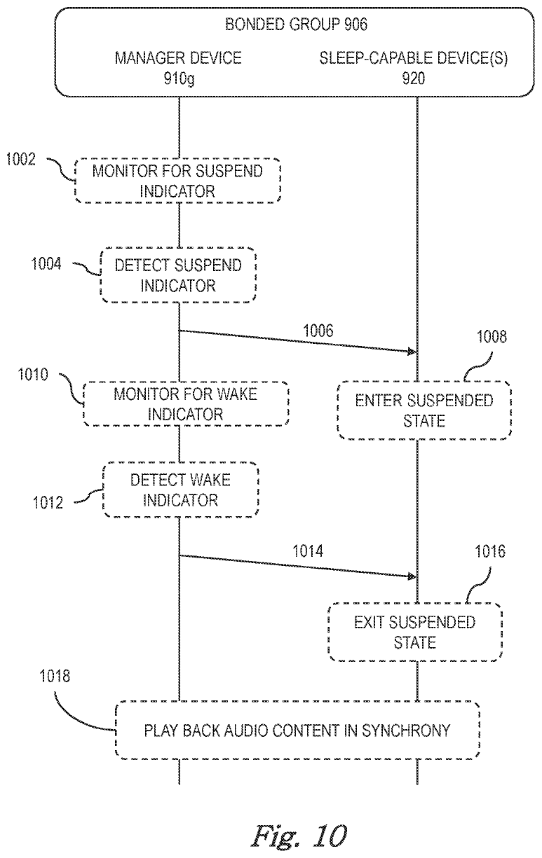

FIG. 10 is a sequence diagram of one example of operating a bonded group in accord with aspects of the technology disclosed herein. A bonded group 906 includes a manager device 910g and one or more sleep-capable playback devices 920. At least some of the sleep-capable playback devices 920 may be always-powered devices. The bonded group 906 may be the stereo pair 902 or home theater group 904 discussed above, or another bonded group including one or more sleep-capable playback device(s) 920. As discussed above, the manager device 910g (which may be either of the manager devices 910a or 910e discussed above) may or may not be sleep-capable, but even if sleep-capable, does not enter the suspended state but remains active to perform its role as the manager device (in terms of the power-saving techniques discussed herein) for the bonded group 906.

At 1002, the manager device 910g monitors for a suspend indicator. As discussed above, the suspend indicator may include a variety of different conditions or events. For example, the suspend indicator may be based on a sleep schedule that has been set up for the bonded group 906. In another example, the suspend indicator may be based on the bonded group being idle for a predetermined amount of time. For example, the manager device 910g may determine that the manager device 910g (or the bonded group 906 as a whole) has not received, for a predetermined time interval, control information that instructs the bonded group 906 to play back audio content. Such a determination may correspond to detecting the suspend indicator at 1004. In another example, the suspend indicator may correspond to a user input. For example, detecting the suspend indicator at 1004 may include detecting a user command, either via the user interface 113 or via voice input, that instructs the bonded group 906 to sleep.

Upon detection of the suspend indicator at 1004, the manager device 910g causes the remaining sleep-capable playback devices 920 in the bonded group 906 to enter the suspended state, as indicated at 1006. In examples, at 1006, the manager device 910g sends one or more messages to the sleep-capable playback devices 920 to instruct the sleep-capable playback devices 920 to enter the suspended state.

At 1008, the sleep-capable playback devices 920 enter the suspended state. As discussed above, in the suspended state, the main processor 504 is disabled, and the operating system 402 and user-space programs 404, 406 are not executing. In each suspended playback device, the auxiliary processor 506, and the PSoC 508 where included in the circuitry 500, remain operational to monitor for messages from the manager device 910g that instruct the suspended playback device to exit the suspended state, as discussed above with reference to FIGS. 4 and 5.

While the sleep-capable playback devices 920 are in the suspended state, the manager device 910g remains active and, at 1010, monitors for a wake indicator. As discussed above, the wake indicator can include a variety of conditions or events. In one example, the wake indicator is based on a sleep schedule that has been set up for bonded group 906. In another example, the wake indicator is based on a user input, such as a command for the bonded group to begin playback of audio content. In the case of the home theater bonded group 904, the wake indicator may be based on a user turning on a television that is associated with the home theater group 904. Various other examples are possible, as will be appreciated given the benefit of this disclosure.

Upon detection of the wake indicator at 1012, the manager device 910g causes the suspended playback devices 920 to resume. In examples, at 1014, the manager device 910g sends one or more messages to the suspended playback devices 920. The messages may be detected at the suspended playback devices 920 via the PSoC 508 and/or auxiliary processor 506 as discussed above.

To cause each suspended playback device to exit the suspended state at 1016, the auxiliary processor 506 resumes the main processor 504 as discussed above. After the main processor 504 is woken up, the kernel resumes and the operating system 402 and user-space programs 404, 406 can begin executing on the main processor 504. In examples in which the wake indicator is a command for the bonded group 906 to begin playback of audio content, after the kernel resumes, the control program 404a executes on the main processor 504 to enable the playback devices 920 to begin playback of the audio content in synchrony with each other and with the manager device 910g at 1016, as discussed above with reference to FIGS. 1B, 1E, and 1I-1M, for example.

Thus, aspects and embodiments provide techniques by which idle playback devices in a media playback system can reduce energy consumption by entering a suspended state in which certain electronic components are powered down. By maintaining at least one coordinator or manager device (that is capable of waking suspended devices) in an active state to monitor for user input or other events, other playback devices can safely enter the suspended state without compromising a user's ability to interact with the media playback system on demand. In some examples, a visual indicator may be provided to the user to identify playback devices that are in the suspended state. For example, a light (e.g., an LED) in the user interface 313 discussed above, may change color or blink to indicate that the playback device is in the suspended state. However, in other examples, because the manager device can resume any suspended playback device(s) at any time, a visual indicator of a playback device being in the suspended state may not be needed.

### V. Conclusion

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways to implement such systems, methods, apparatus, and/or articles of manufacture.

Additionally, references herein to “embodiment” means that a particular feature, structure, or characteristic described in connection with the embodiment can be included in at least one example embodiment disclosed herein. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

### VI. Additional Examples

The following examples pertain to further embodiments, from which numerous permutations and configurations will be apparent.

Example 1 provides a playback device comprising a communications interface including a wireless radio, one or more speakers, one or more amplifiers configured to drive the one or more speakers, at least one processor, and at least one non-transitory computer-readable medium. The at least one computer-readable medium comprises program instructions that are executable by the at least one processor to control the playback device to play back audio content, via the one or more speakers and the one or more amplifiers, synchronously with at least one other playback device, based on a sleep indication, direct, via communication of at least one message to the at least one other playback device using the wireless radio, the at least one other playback device to enter a suspended state in which the at least one other playback device suspends an operating system and one or more programs, the one or more programs including a control program configured to instruct the at least one other playback device to play back the audio content, while the at least one other playback device is in the suspended state, monitor for a wake-up indication, and based on detection of the wake-up indication, direct, via communication of at least one message to the at least one other playback device using the wireless radio, the at least one other playback device to resume execution of the operating system and the one or more programs.

Example 2 includes the playback device of Example 1, wherein to identify the sleep indication, the program instructions further comprise program instructions that are executable by the at least one processor to control the playback device to determine that the at least one other playback device has not received, for a predetermined time interval, control information that instructions the at least one other playback device to play back the audio content.

Example 3 includes the playback device of one of Examples 1 and 2, wherein the sleep indication comprises an indication of a scheduled sleep time.

Example 4 includes the playback device of any one of Examples 1-3, wherein the wake-up indication includes a command to begin play back of selected audio content.

Example 5 includes the playback device of Example 4, wherein the at least one non-transitory computer-readable medium further comprises instructions that are executable by the at least one processor to control the playback device to, after detection of the command to begin play back of the selected audio content, play back the selected audio content via the one or more speakers and the one or more amplifiers.

Example 6 includes the playback device of Example 5, wherein the at least one non-transitory computer-readable medium further comprises instructions that are executable by the at least one processor to control the playback device to send a message to the at least one other playback device to cause the at least one other playback device, after resumption of the operating system and the one or more programs, to play back the selected audio content in synchrony with the playback device.

Example 7 includes the playback device of one of Examples 5 and 6, further comprising a microphone configured to detect the command to begin play back of the selected audio content.

Example 8 includes the playback device of any one of Examples 1-7, wherein the wake-up indication comprises an indication of a scheduled wake-up time.

Example 9 provides a playback device comprising a communications interface including a wireless radio, one or more speakers, one or more amplifiers configured to drive the one or more speakers, at least one processor, and at least one non-transitory computer-readable medium. The at least one computer-readable medium stores program instructions that are executable by the at least one processor to control the playback device to operate in a media playback system comprising the playback device and a plurality of additional playback devices, to operate in the media playback system comprising to, using the one or more speakers and the one or more amplifiers, play back audio content in synchrony with play back of the audio content by at least one playback device of the plurality of additional playback devices, identify, based on one or more capabilities of the plurality of additional playback devices, a subset of the plurality of additional playback devices, based on a sleep indication, cause, via communication of at least one message to the subset of additional playback devices using the wireless radio, the subset of additional playback devices to enter a suspended state in which each additional playback device in the subset of additional playback devices suspends an operating system and one or more programs, the one or more programs including a control program configured to instruct the additional playback device to play back the audio content, while the subset of additional playback devices is in the suspended state, monitor for a wake-up indication, and based on the wake-up indication, cause, via communication of at least one message to the subset of additional playback devices using the wireless radio, the subset of additional playback devices to resume execution of the operating system and the one or more programs.

Example 10 includes the playback device of Example 9, wherein the one or more capabilities include a first capability to enter a sleep mode and a second capability to detect ambient sound using one or more microphones.

Example 11 includes the playback device of Example 10, wherein to identify the subset of additional playback devices, the at least one non-transitory computer-readable medium further comprises instructions that are executable by the at least one processor to control the playback device to identify the subset of additional playback devices as those additional playback devices having the sleep capability.

Example 12 includes the playback device of any one of Examples 9-11, wherein the sleep indication comprises an indication of a scheduled sleep time.

Example 13 includes the playback device of any one of Examples 9-12, wherein the wake-up indication includes a detection of a command to begin play back of selected audio content in synchrony with at least one of the additional playback devices in the subset of additional playback devices.

Example 14 includes the playback device of Example 13, wherein the at least one non-transitory computer-readable medium further comprises instructions that are executable by the at least one processor to control the playback device to send a message to the at least one additional playback device in the subset of additional playback devices to cause the at least one additional playback device, after resumption of the operating system and the one or more programs, to play back the selected audio content in synchrony with the playback device.

Example 15 includes the playback device of one of Examples 13 and 14, further comprising a microphone configured to detect the command to begin play back of the selected audio content.

Example 16 includes the playback device of any one of Examples 9-15, wherein the wake-up indication comprises an indication of a scheduled wake-up time.

Example 17 provides a method of operating a media playback system including a plurality of playback devices, the method comprising identifying a first playback device of the plurality of playback devices, identifying a subset of the plurality of playback devices as a sleep group of playback devices, wherein the sleep group does not include the first playback device, identifying, with the first playback device, a sleep indicator, and based on identifying the sleep indicator, causing, via communication of at least one message from the first playback device to the sleep group of playback devices, the sleep group of playback devices to enter a suspended state in which each playback device in the sleep group of playback devices suspends an operating system and one or more programs, the one or more programs including a control program configured to instruct the respective playback device to play back audio content. The method further comprises identifying, with the first playback device, a wake-up indicator, based on identifying the wake-up indicator, causing, via communication of at least one message from the first playback device to the sleep group of playback devices, the sleep group of playback devices to resume execution of the operating system and the one or more programs, and causing, via communication of a message from the first playback device to at least one playback device in the sleep group of playback devices, the at least one playback device to, after resuming execution of the operating system and the one or more programs, play back selected audio content in synchrony with the first playback device.

Example 18 includes the method of Example 17, wherein identifying the sleep indicator comprises determining that the sleep group of playback devices have not received, for a predetermined time interval, control information that instructs one or more of the sleep group of playback devices to play back audio content.

Example 19 includes the method of one of Examples 17 and 18, wherein identifying the wake-up indicator includes detecting, at the first playback device, a command to begin play back of selected audio content in synchrony with at least one playback device in the sleep group of playback devices.

Example 20 includes the method of any one of Examples 17-19, wherein identifying the wake-up indicator includes identifying, based on a preset sleep schedule for the sleep group of playback devices, a scheduled wake-up time.

Example 21 includes the method of Example 20, wherein identifying the sleep indicator includes identifying, based on the preset sleep schedule, a scheduled sleep time.

Example 22 includes the method of any one of Examples 17-21, wherein identifying the first playback device includes identifying a playback device having at least one microphone.

Example 23 includes the method of any one of Examples 17-22, wherein identifying the wake-up indicator includes detecting, at the first playback device, a wake-on-wireless trigger.

Example 24 provides a playback device configured to implement the method of any one of Examples 17-23.

Example 25 provides a playback device comprising a communications interface including a wireless radio, one or more speakers, one or more amplifiers configured to drive the one or more speakers, at least one processor, and at least one non-transitory computer-readable medium. The at least one computer-readable medium comprises program instructions that are executable by the at least one processor to control the playback device to, using the one or more speakers and the one or more amplifiers, playback at least one channel of audio content synchronously with playback of at least one other channel of the audio content by at least one other playback device in a bonded group, determine, while the playback device is in the bonded group with the at least one other playback device, that the playback device has not received, for a predetermined time interval, control information that instructs the playback device to playback the audio content, based on the determination, cause, via communication of at least one message to the at least one other playback device in the bonded group using the wireless radio, the at least one other playback device to enter a suspended state in which the at least other playback device suspends an operating system and one or more programs, the one or more programs including a control program configured to instruct the at least one other playback device to playback the audio content, monitoring for a wake-up indicator while the at least one other playback device in the bonded group is in the suspended state, and based on detecting the wake-up indicator, cause, via communication of at least one message to the at least one other playback device using the wireless radio, the at least one other playback device to resume execution of the operating system and the one or more programs.

Example 26 includes the playback device of Example 25, wherein the wake-up indicator includes a command to begin playback of selected audio content.

Example 27 includes the playback device of Example 26, wherein the at least one non-transitory computer-readable medium further comprises instructions that are executable by the at least one processor to control the playback device to, after detection of the wake-up indicator, playback the selected audio content via the one or more speakers and the one or more amplifiers.

Example 28 includes the playback device of Example 27, wherein the at least one non-transitory computer-readable medium further comprises instructions that are executable by the at least one processor to control the playback device to send a message to the at least one other playback device to cause the at least one other playback device, after resumption of the operating system and the one or more programs, to playback the selected audio content in synchrony with the playback device.

Example 29 includes the playback device of any one of Examples 25-28, further comprising a microphone configured to detect the wake-up indicator.

Example 30 provides a method of operating a plurality of playback devices configured as a bonded group, the method comprising determining that, for a predetermined time period, the bonded group of playback devices has not received control information directing the bonded group of playback devices to playback audio content, based on the determining, selecting one or more playback devices in the bonded group to identify a subset of playback devices to enter a suspended state, and sending sleep instructions to the subset of playback devices to cause each playback device in the subset of playback devices to suspend an operating system and one or more programs, the one or more programs including a control program configured to instruct a respective playback device to playback the audio content in synchrony with other playback devices in the bonded group.

Example 31 includes the method of Example 30, wherein selecting the subset of playback devices includes selecting the one or more playback devices in the bonded group that do not have microphone capability.

Example 32 includes the method of one of Examples 31 and 32, further comprising detecting a wake-up indicator, and based on detecting the wake-up indicator, sending wake instructions to the subset of playback devices to cause each playback device in the subset of playback devices to resume execution of the operating system and the one or more programs.

Example 33 includes the method of Example 32, wherein detecting the wake-up indicator includes detecting a command to begin playback of selected audio content.

Example 34 includes the method of any one of Examples 30-33, wherein the bonded group is a stereo pair including a first playback device having a microphone and a second playback device that does not have a microphone, and wherein selecting the subset of playback devices includes selecting the second playback device.

Example 35 includes the method of Example 32, wherein detecting the wake-up indicator includes detecting the wake-up indicator at the first playback device, and wherein sending the wake instructions includes sending the wake instructions from the first playback device to the second playback device.

Example 36 includes the method of Example 35, further comprising beginning playback of the selected audio content by the first playback device, and sending instructions from the first playback device to the second playback device to cause the second playback device to begin playback of the selected audio content in synchrony with playback of the first audio content by the first playback device.

Example 37 includes the method of any one of Examples 32-36, wherein detecting the wake-up indicator includes detecting the wake-up indicator via at least one playback device of the bonded group that is not in the subset.

Example 38 includes the method of Example 37, further comprising based on detecting the command to begin the playback of the selected audio content, playing back the selected audio content with the at least one playback device of the bonded group that is not in the subset, and sending instructions from the at least one playback device of the bonded group that is not in the subset to the subset of playback devices to cause the subset of playback devices to playback the selected audio content in synchrony with the at least one playback device of the bonded group that is not in the subset.

Example 39 includes the method of Example 38, further comprising achieving sufficient time synchrony for playback of the selected audio content between the at least one playback device of the bonded group that is not in the subset and the subset of playback devices, and after achieving the sufficient time synchrony, playing back the selected audio content by the subset of playback devices in synchrony with the at least one playback device of the bonded group that is not in the subset.

Example 40 includes the method of any one of Examples 32-39, wherein detecting the wake-up indicator includes receiving a wake-on-wireless trigger.

Example 41 provides a playback device configured to implement the method of any one of Examples 30-40.

Example 42 provides a playback device comprising at least one processor, one or more speakers, one or more amplifiers configured to drive the one or more speakers, a communications interface including a wireless radio, and at least one non-transitory computer-readable medium storing program instructions that are executable by the at least one processor to control the playback device to operate in a bonded group comprising the playback device and a plurality of satellite playback devices. To operate in the bonded group comprises to determine that the playback device has not received, for a predetermined time interval, control information that instructs the playback device to playback audio content, identify, based on one or more capabilities of the plurality of satellite playback devices, a first subset of the plurality of satellite playback devices and a second subset of the plurality of satellite playback devices, and send, via the wireless radio, sleep instructions to the first subset of satellite playback devices to control each satellite playback device in the first subset of satellite playback device to suspend an operating system and one or more programs, the one or more programs including a control program configured to instruct the satellite playback device to playback the audio content.

Example 43 includes the playback device of Example 41, wherein the at least one non-transitory computer-readable medium further stores program instructions that are executable by the at least one processor to control the playback device to, after receiving the control information instructing the bonded group to begin playback of the audio content, send, via the wireless radio, wake instructions to the first subset of satellite playback devices to cause each satellite playback device to resume execution of the operating system and the one or more programs.

Example 44 includes the playback device of Example 43, wherein the at least one non-transitory computer-readable medium further stores program instructions that are executable by the at least one processor to control the playback device to, after sending the wake instructions to the first subset of satellite playback devices, transmit, using the wireless radio, one or more channels of the audio content to the plurality of satellite playback devices, and render, using the one or more speakers and the one or more amplifiers, at least one channel of the audio content in synchrony with rendering of the one or more channels of audio content by the plurality of satellite playback devices.

Example 45 includes the playback device of one of Examples 43 and 44, wherein sending the wake instructions to the first subset of satellite playback devices includes sending wake-on-wireless data packets to the first subset of satellite playback devices.

Example 46 includes the playback device of any one of Examples 42-45, wherein the one or more capabilities of the plurality of satellite playback devices include sleep capability.

Example 47 includes the playback device of any one of Examples 42-46, wherein one or more capabilities of the plurality of satellite playback devices include microphone capability.

Example 48 includes the playback device of any one of Examples 42-48, wherein the playback device is a soundbar.

Example 49 provides a playback device comprising one or more speakers, one or more amplifiers configured to drive the one or more speakers, a communications interface including a wireless radio, circuitry comprising a plurality of processors including one or more first processors and one or more second processors, and at least one non-transitory computer-readable medium comprising program instructions that are executable by the plurality of processors to control the playback device to operate in a bonded group comprising the playback device and at least one other playback device. To operate in the bonded group comprises to, after a first predetermined time interval during which the playback device has not rendered audio content, receive, via the wireless radio, sleep instructions from the at least one other playback device in the bonded group, based on receiving the sleep instructions, suspend an operating system and one or more programs, the one or more programs including a control program configured to instruct the playback device to render the audio content, detect, via the wireless radio and the one or more second processors, a wake command from the at least one other playback device in the bonded group, and cause, using the one or more second processors, the one or more first processors to resume execution of the operating system and the one or more programs.

Example 50 includes the playback device of Example 49, wherein the wake command includes a wake-on-wireless trigger.

Example 51 includes the playback device of one of Examples 49 and 50, wherein the at least one non-transitory computer-readable medium further comprises program instructions that are executable by the at least one processor to control the playback device to, after resumption of the operating system and the one or more programs, receive, via the wireless radio, one or more channels of audio content, and using the control program and the one or more first processors, playback the one or more channels of audio content via the one or more speakers and the one or more amplifiers in synchrony with playback of one or more other channels of audio content by the at least one other playback device in the bonded group.

Example 52 includes the playback device of any one of Examples 49-51, wherein the at least one non-transitory computer-readable medium further comprises program instructions that are executable by the at least one processor to control the playback device to, after a second predetermined time interval after detecting the wake command during which the playback device has not rendered the audio content, re-suspend the operating system and the one or more programs.

1-37. (canceled)

38. A playback device comprising:
a communications interface including a wireless radio;
one or more speakers;
one or more amplifiers configured to drive the one or more speakers;
at least one processor; and
at least one non-transitory computer-readable medium comprising program instructions that are executable by the at least one processor to control the playback device to:
using the one or more speakers and the one or more amplifiers, play back at least one channel of audio content synchronously with playback of at least one other channel of the audio content by at least one other playback device in a bonded group;
determine, while the playback device is in the bonded group with the at least one other playback device, that the playback device has not received, for a predetermined time interval, control information that instructs the playback device to play back the audio content;
based on the determination, cause, via communication of at least one message to the at least one other playback device in the bonded group using the wireless radio, the at least one other playback device to enter a suspended state in which the at least other playback device suspends an operating system and one or more programs, the one or more programs including a control program configured to instruct the at least one other playback device to play back the audio content;
monitor for a wake-up indicator while the at least one other playback device in the bonded group is in the suspended state; and
based on detecting the wake-up indicator, cause, via communication of at least one message to the at least one other playback device using the wireless radio, the at least one other playback device to resume execution of the operating system and the one or more programs.

39. The playback device of claim 38, wherein the wake-up indicator includes a command to begin playback of selected audio content.

40. The playback device of claim 39, wherein the at least one non-transitory computer-readable medium further comprises instructions that are executable by the at least one processor to control the playback device to:
after detection of the wake-up indicator, play back the selected audio content via the one or more speakers and the one or more amplifiers.

41. The playback device of claim 40, wherein the at least one non-transitory computer-readable medium further comprises instructions that are executable by the at least one processor to control the playback device to:
send a message to the at least one other playback device to cause the at least one other playback device, after resumption of the operating system and the one or more programs, to play back the selected audio content in synchrony with the playback device.

42. The playback device of claim 38, further comprising:
a microphone configured to detect the wake-up indicator.

43. A method of operating a plurality of playback devices configured as a bonded group, the method comprising:
determining that, for a predetermined time period, the bonded group of playback devices has not received control information directing the bonded group of playback devices to play back audio content;
based on the determining, selecting one or more playback devices in the bonded group to identify a subset of playback devices to enter a suspended state; and
sending sleep instructions to the subset of playback devices to cause each playback device in the subset of playback devices to suspend an operating system and one or more programs, the one or more programs including a control program configured to instruct a respective playback device to play back the audio content in synchrony with other playback devices in the bonded group.

44. The method of claim 43, wherein selecting the subset of playback devices includes selecting the one or more playback devices in the bonded group that do not have microphone capability.

45. The method of claim 43, further comprising:
detecting a wake-up indicator; and
based on detecting the wake-up indicator, sending wake instructions to the subset of playback devices to cause each playback device in the subset of playback devices to resume execution of the operating system and the one or more programs.

46. The method of claim 45, wherein detecting the wake-up indicator includes detecting a command to begin playback of selected audio content.

47. The method of claim 46, wherein the bonded group is a stereo pair including a first playback device having a microphone and a second playback device that does not have a microphone, and wherein selecting the subset of playback devices includes selecting the second playback device.

48. The method of claim 47, wherein detecting the wake-up indicator includes detecting the wake-up indicator at the first playback device; and
wherein sending the wake instructions includes sending the wake instructions from the first playback device to the second playback device.

49. The method of claim 48, further comprising:
beginning playback of the selected audio content by the first playback device; and
sending instructions from the first playback device to the second playback device to cause the second playback device to begin playback of the selected audio content in synchrony with playback of the selected audio content by the first playback device.

50. The method of claim 46, wherein detecting the wake-up indicator includes detecting the wake-up indicator via at least one playback device of the bonded group that is not in the subset.

51. The method of claim 50, further comprising:
based on detecting the command to begin the playback of the selected audio content, playing back the selected audio content with the at least one playback device of the bonded group that is not in the subset; and
sending instructions from the at least one playback device of the bonded group that is not in the subset to the subset of playback devices to cause the subset of playback devices to play back the selected audio content in synchrony with the at least one playback device of the bonded group that is not in the subset.

52. The method of claim 51, further comprising:
achieving sufficient time synchrony for playback of the selected audio content between the at least one playback device of the bonded group that is not in the subset and the subset of playback devices; and
after achieving the sufficient time synchrony, playing back the selected audio content by the subset of playback devices in synchrony with the at least one playback device of the bonded group that is not in the subset.

53. The method of claim 46, detecting the wake-up indicator includes detecting a wake-on-wireless trigger.

54. A playback device comprising:
at least one processor;
one or more speakers;
one or more amplifiers configured to drive the one or more speakers;
a communications interface including a wireless radio; and
at least one non-transitory computer-readable medium storing program instructions that are executable by the at least one processor to control the playback device to operate in a bonded group comprising the playback device and a plurality of satellite playback devices, to operate in the bonded group comprising to
determine that the playback device has not received, for a predetermined time interval, control information that instructs the playback device to playback audio content;
identify, based on one or more capabilities of the plurality of satellite playback devices, a first subset of the plurality of satellite playback devices and a second subset of the plurality of satellite playback devices, and
send, via the wireless radio, sleep instructions to the first subset of satellite playback devices to control each satellite playback device in the first subset of satellite playback device to suspend an operating system and one or more programs, the one or more programs including a control program configured to instruct the satellite playback device to playback the audio content.

55. The playback device of claim 54, wherein the at least one non-transitory computer-readable medium further stores program instructions that are executable by the at least one processor to control the playback device to:
after receiving the control information instructing the bonded group to begin playback of the audio content, send, via the wireless radio, wake instructions to the first subset of satellite playback devices to cause each satellite playback device to resume execution of the operating system and the one or more programs.

56. The playback device of claim 55, wherein the at least one non-transitory computer-readable medium further stores program instructions that are executable by the at least one processor to control the playback device to:
after sending the wake instructions to the first subset of satellite playback devices, transmit, using the wireless radio, one or more channels of the audio content to the plurality of satellite playback devices, and
render, using the one or more speakers and the one or more amplifiers, at least one channel of the audio content in synchrony with rendering of the one or more channels of audio content by the plurality of satellite playback devices.

57. The playback device of claim 55, wherein sending the wake instructions to the first subset of satellite playback devices includes sending wake-on-wireless data packets to the first subset of satellite playback devices.

58. The playback device of claim 54, wherein the one or more capabilities of the plurality of satellite playback devices include sleep capability.

59. The playback device of claim 54, wherein one or more capabilities of the plurality of satellite playback devices include microphone capability.

60. The playback device of claim 54, wherein the playback device is a soundbar.

61. A playback device comprising:
one or more speakers;
one or more amplifiers configured to drive the one or more speakers;
a communications interface including a wireless radio;
circuitry comprising a plurality of processors including one or more first processors and one or more second processors; and
at least one non-transitory computer-readable medium comprising program instructions that are executable by the plurality of processors to control the playback device to operate in a bonded group comprising the playback device and at least one other playback device, to operate in the bonded group comprising to
after a first predetermined time interval during which the playback device has not rendered audio content, receive, via the wireless radio, sleep instructions from the at least one other playback device in the bonded group,
based on detecting the sleep instructions, suspend an operating system and one or more programs, the one or more programs including a control program configured to instruct the playback device to render the audio content,
detect, via the wireless radio and the one or more second processors, a wake indicator from the at least one other playback device in the bonded group, and.
cause, using the one or more second processors, the one or more first processors to resume execution of the operating system and the one or more programs.

62. The playback device of claim 61, wherein the wake indicator includes a wake-on-wireless trigger.

63. The playback device of claim 61, wherein the at least one non-transitory computer-readable medium further comprises program instructions that are executable by the at least one processor to control the playback device to:
after resumption of the operating system and the one or more programs, receive, via the wireless radio, one or more channels of audio content, and
using the control program and the one or more first processors, playback the one or more channels of audio content via the one or more speakers and the one or more amplifiers in synchrony with playback of one or more other channels of audio content by the at least one other playback device in the bonded group.

64. The playback device of claim 61, wherein the at least one non-transitory computer-readable medium further comprises program instructions that are executable by the at least one processor to control the playback device to:
after a second predetermined time interval after detecting the wake indicator during which the playback device has not rendered the audio content, re-suspend the operating system and the one or more programs.
